(19) United States
(12) Patent Application Publication
(10) Pub. No.: US 2017/0351364 A1
(43) Pub. Date: Dec. 7, 2017

(54) Method of Driving Display Device Capable of Scanning Image

(71) Applicant: Crucialtec Co., Ltd., Gyeonggi-do (KR)

(72) Inventors: Jong Uk KIM, Gyeonggi-do (KR); Ho Sik Jeon, Chungcheongnam-do (KR)

(21) Appl. No.: 15/526,687

(22) PCT Filed: Nov. 10, 2015
(86) PCT No.: PCT/KR2015/012026

§ 371 Date: May 12, 2017

(30) Foreign Application Priority Data
Nov. 12, 2014 (KR) 10-2014-0156873
Mar. 30, 2015 (KR) 10-2015-0044067
Nov. 10, 2015 (KR) 10-2015-0157052

(51) Int. Cl. G06F 3/041; G06K 9/00; G06F 3/044; H01L 27/32

(52) U.S. Cl. CPC G06F 3/0412; H01L 27/32; G06K 9/001; G06F 3/044; G06K 9/0008; G09G 2300/0439

(57) ABSTRACT

Disclosed in the present specification is a method for driving a display device capable of scanning an image, the display device comprising: a display module including a plurality of unit pixels arranged in a display area in which an image is displayed; and a contact sensor module forming a sensing area, which overlaps with the display area, and including at least one contact sensor respectively corresponding to the unit pixels, and the method comprising: a sensing mode identification step of identifying a sensing mode of the display device; a contact sensor selection step of selecting contact sensors to be activated, according to the identified sensing mode; and a contact sensor activation and sensing step of activating the selected contact sensors and receiving sensing signals from the activated contact sensors.

### TECHNICAL FIELD

The present disclosure relates to a method of driving a display device capable of scanning an image.

### BACKGROUND ART

A touch screen panel is a device for inputting a user command by a letter or a figure displayed on a screen of an image display device coming into contact with a person's finger or other contact means, and is used by being attached to an upper portion of the image display device. The touch screen panel converts a contact position touched by a person's finger and the like into an electrical signal. The electrical signal is used as an input signal.

A touch detecting method in a touch screen panel has various types such as a resistive film method, an optical method, a capacitance method, and an ultrasonic method. Among these, in the capacitance method, whether a touch is generated is detected using a capacitance which changes when a touch generator comes into contact with a screen of a display device. A touch screen panel using the capacitance method may detect a touch by a person's finger, a conductive touch pen, and the like.

Meanwhile, as security-related problems are coming into the fore nowadays, security of personal portable devices such as a smartphone and a table personal computer (PC) is becoming an issue. As users more frequently use portable devices, security is in demand for electronic commerce and the like through the portable devices. To meet the demand, biometric information such as fingerprints, irises, faces, voices, and blood vessels is used.

Among various biometric information verification technologies, the most commonly used technology is a verification technology through fingerprints. Recently, products to which fingerprint recognition and a verification technology using the same are applied, such as a smartphone and a tablet personal computer (PC), have been released.

However, to graft sensors for fingerprint recognition onto portable devices, a device for fingerprint recognition has to be installed in addition to an image display device. Accordingly, there is a problem in that a volume of a portable device is increased.

Consequently, a technology capable of omitting a space for a separate fingerprint recognition sensor in a portable device and preventing a display area from being interfered is required to be developed.

### DISCLOSURE

### Technical Problem

An objective of the present disclosure is to design one or more touch sensors to correspond to each pixel unit of a display module so that an image touched on a display screen can be scanned from at least a portion of a display device.

### Technical Solution

According to a method of driving a display device capable of scanning an image according to an embodiment of the present disclosure, a method of driving a display device capable of scanning an image, the display device including a display module including a plurality of pixel units arranged in a display area on which an image is displayed and a touch sensor module having a sensing area which overlaps the display area and including one or more touch sensors respectively corresponding to the pixel units, includes a sensing mode discriminating step in which a sensing mode of the display device is discriminated; a touch sensor selecting step in which touch sensors to be activated are selected according to the discriminated sensing mode, and a touch sensor activating and sensing step in which the selected touch sensors are activated and a sensed signal is received from the activated touch sensors.

In the sensing mode discriminating step, the sensing mode may include a touch recognition mode for recognizing whether a contact means comes into contact with the display device by partitioning the sensing area of the display device and allowing some touch sensors of the touch sensors included in a plurality of touch sensor sectors including the touch sensors disposed in the partitioned area to be selected; and fingerprint recognition modes for scanning an image of a user's fingerprint which touches the display device by allowing a larger number of the touch sensors to be selected than in the touch recognition mode.

The touch sensors may be connected to a scan line to which a scan signal for providing a driving voltage to the touch sensors is applied. The touch sensor module may further include a plurality of touch sensor blocks each including two or more of the touch sensor sectors. The sensing mode may further include a non-contact recognition mode for recognizing whether the contact means is in the vicinity of the sensing area by allowing some touch sensors of the touch sensors included in the touch sensor blocks to be selected. When the non-contact sensing mode is selected, a size of a voltage of the scan signal applied to the touch sensors may be larger compared to when any one of the touch recognition mode and the fingerprint recognition mode is selected.

The method may further include a reference voltage exceeding determining step in which whether a voltage value of a detection signal generated from the touch sensors exceeds a non-contact recognition reference voltage is determined when the non-contact recognition mode is selected in the sensing mode discriminating step and the touch sensor activating and sensing step is performed on the touch sensors selected according to the non-contact recognition mode. In the reference voltage exceeding determining step, when the voltage value of the detection signal is the reference voltage or lower, the touch sensor block from which the detection signal is generated among the plurality of touch sensor blocks may be determined as a center of non-contact recognition. In the reference voltage exceeding determining step, when the voltage value of the detection signal exceeds the reference voltage, the touch sensor activating and sensing step may be performed according to the touch recognition mode.

The fingerprint recognition modes may include an entire fingerprint recognition mode which allows all of the touch sensors of the display device to be selected; an icon fingerprint recognition mode which allows a plurality of touch sensors which overlap at least one icon of a plurality of icons displayed on the display device to be selected; and an input window fingerprint recognition mode which allows a plurality of touch sensors which overlap an input window displayed on a partial area of the display device to be selected.

In the sensing mode discriminating step, when any one of the icon fingerprint recognition mode and the input window fingerprint recognition mode is selected from the fingerprint recognition modes, some touch sensors of the touch sensors disposed in an area excluding an area in which the touch sensors overlapping the icon or the input window are disposed may be further selected.

In the sensing mode discriminating step, when the touch recognition mode is selected, the selected touch sensors of the touch sensor sectors may be disposed along an edge of the touch sensor sector or randomly disposed in the touch sensor sector.

The method may further include a touch point determining step in which a touch point is determined on the basis of sensed information received from the touch sensors from which contact of the contact means overlapping the plurality of touch sensors is sensed. In the touch point determining step, 1) a center of the touch sensor sector including the largest number of touch sensors of the touch sensors from which the contact is sensed or 2) a calculated center which is spaced apart, by a weighted average value of the number of touch sensors from which the contact is sensed included by each of the touch sensor sectors, from centers of the touch sensor sectors including the touch sensors from which the contact is sensed may be determined as a center of a touch point.

Of the plurality of touch sensor sectors, any one touch sensor sector and another touch sensor sector adjacent thereto may share one or more touch sensors.

A touch sensor which is not included in any of the touch sensor sectors may be disposed between any one touch sensor sector of the touch sensor sectors and another touch sensor sector adjacent thereto.

The touch sensor may include a sensing electrode configured to form a touch capacitance by contact with a contact means and formed of a transparent material and a transistor part including one or more transistors connected to the sensing electrode. The sensing electrode may overlap the pixel unit of the display module, and light for displaying an image may pass through the sensing electrode from the pixel unit.

The transistor part may include a reset transistor in which a drain electrode is connected to the sensing electrode and any one of a gate electrode and a source electrode is connected to a first scan line to which a first selection signal is applied or a data line which provides a data signal, an amplifying transistor in which a gate electrode is connected to the drain electrode of the reset transistor and a source electrode is connected to any one of the first scan line, the data line, and a second scan line to which a second selection signal, which is different from the first selection signal, is applied; and a read transistor in which a drain electrode is connected to the drain electrode of the amplifying transistor, a gate electrode is connected to the second scan line to which the second selection signal is applied, and a source electrode is connected to a readout line for detecting a current corresponding to the touch capacitance.

The touch sensor activating and sensing step may include charging the touch capacitance formed between the sensing electrode and the contact means through the reset transistor which is turned on by receiving the first selection signal; generating a current which varies according to a voltage charged in the touch capacitance through the amplifying transistor; and determining whether a touch is generated on an upper portion of the touch sensor and a contact state by detecting the generated current through the read transistor which is turned on by receiving the second selection signal.

The sensing electrode may be disposed higher than the reset transistor, the amplifying transistor, the read transistor, the first scan line, the second scan line, the data line, and the readout line.

The sensing electrode may cover one or more of the reset transistor, the amplifying transistor, the read transistor, a portion of the first scan line, a portion of the second scan line, a portion of the data line, and a portion of the readout line.

The reset transistor, the amplifying transistor, and the read transistor may be disposed not to cover unit color pixels of a color filter layer of the display module, and the sensing electrode may be disposed to cover at least some of the unit color pixels.

Any one touch sensor of the plurality of touch sensors and another touch sensor adjacent thereto may be connected to the single data line. The touch sensor and the other touch sensor adjacent thereto may be symmetrical with respect to the data line.

The data line may be formed of a plurality of data lines to which data signals formed independent of each other are respectively input. Sequentially formed scan signals may be respectively input to the plurality of scan lines including the first scan line and the second scan line, a touch sensor to which a scan signal and a data signal are simultaneously input may be activated, and a touch sensor to which at least one of the scan signal and the data signal is not input may not be activated.

The display device may further include a protective layer having one surface coming into contact with the sensing electrode of the touch sensor and the other surface coming into contact with a user's fingerprint. An image of the user's fingerprint can be scanned by detecting currents having different values according to touch capacitances of ridges and valleys of the user's fingerprint which touches the protective layer.

A gap may be formed between a sensing electrode of any one touch sensor of the plurality of touch sensors and a sensing electrode of another touch sensor. The sensing electrode of the touch sensor and a single gap adjacent thereto may form a single sensing pitch. A width of the sensing pitch may be any one selected from a range of 5 μm to 200 μm.

### Effects of the Disclosure

According to an embodiment of the present disclosure, a size of a detection signal can be increased using a coupling phenomenon by a parasitic capacitance included in a transistor and a peripheral circuit configuration.

Further, according to an embodiment of the present disclosure, visibility of a display device can be improved by configuring a sensor using a transparent electrode.

Further, according to an embodiment of the present disclosure, an image touched on a display screen can be sensed on the display device by designing a touch sensor to have a size of a pixel unit of a display.

Further, by touch sensors of micro-units disposed on the display device, there is an advantage in that an image of a user's fingerprint can be scanned or whether a touch is generated by a contact means having a fine diameter such as a pin or a brush can be sensed.

### BRIEF DESCRIPTION OF DRAWINGS

FIG. 1 is a view illustrating an exterior of an electronic device according to an embodiment of the present disclosure.

FIGS. 2A to 2D are cross-sectional views illustrating a configuration of a display device having an image sensing function according to an embodiment of the present disclosure.

FIG. 3 is a plan view illustrating a configuration of a display device according to an embodiment of the present disclosure.

FIG. 4 is a view illustrating a configuration of a sensor array layer which realizes the image sensing function according to an embodiment of the present disclosure.

FIG. 5 is a circuit diagram illustrating an implementation of a touch sensor disposed on a sensor array.

FIG. 6 is a circuit diagram illustrating a configuration of a capacitance type touch sensor capable of being applied to the display device according to an embodiment of the present disclosure.

FIGS. 7 to 9 are circuit diagrams illustrating a configuration of a capacitance type touch sensor according to another embodiment of the present disclosure.

FIG. 10 is a timing diagram for describing an operation of a touch sensor according to an embodiment of the present disclosure.

FIG. 11 is a plan view of a touch sensor according to an embodiment of the present disclosure.

FIG. 12 is a view illustrating a plan view of a sensor array in which a plurality of touch sensors according to another embodiment of the present disclosure are disposed.

FIG. 13 is an enlarged plan view of a touch sensor in a pixel unit illustrated in FIG. 12.

FIG. 14 is a cross-sectional view taken along line A-A′ of a touch sensor in a pixel unit illustrated in FIG. 12.

FIG. 15 is a cross-sectional view taken along line B-B′ of a touch sensor in a pixel unit illustrated in FIG. 12.

FIG. 16 is a cross-sectional view taken along line C-C′ of a touch sensor in a pixel unit illustrated in FIG. 12.

FIG. 17 is a view illustrating a cross-sectional view of a touch sensor according to still another embodiment of the present disclosure.

FIG. 18 is a plan view of a sensor array in which a plurality of touch sensors according to still another embodiment of the present disclosure are disposed.

FIG. 19 is an enlarged plan view of a touch sensor in a pixel unit illustrated in FIG. 18.

FIG. 20 is a view illustrating a plan view of a touch sensor according to yet another embodiment of the present disclosure.

FIG. 21 is a schematic exploded perspective view of a display device including the touch sensor according to yet another embodiment of the present disclosure.

FIG. 22 is a view illustrating a schematic arrangement of touch sensors in the display device of FIG. 21.

FIG. 23 is a view illustrating a schematic arrangement of touch sensors according to yet another embodiment of the present disclosure.

FIG. 24 is a plan view of the touch sensors of FIG. 23.

FIG. 25 is a view illustrating a state in which the display device including the touch sensors according to yet another embodiment of the present disclosure is driven in a touch recognition mode.

FIG. 26 is a view illustrating a driving state of a touch sensor array in the display device of FIG. 25.

FIG. 27 is a timing diagram for describing an operation of the touch sensors of FIG. 26.

FIG. 28 is a view illustrating a state in which a contact means is in contact in the state of FIG. 27 in which the display device is driven in the touch recognition mode.

FIGS. 29 to 31 are views illustrating a state in which a display device according to yet another embodiment of the present disclosure is driven in a touch recognition mode.

FIG. 32 is a view illustrating a state in which the display device of FIG. 25 is driven in an entire fingerprint recognition mode.

FIG. 33 is a view illustrating a state in which the display device of FIG. 25 is driven in an icon fingerprint recognition mode.

FIG. 34 is a view illustrating a state in which the display device of FIG. 25 is driven in an input window fingerprint recognition mode.

FIG. 35 is a view illustrating a state in which the display device of FIG. 25 is driven in a non-contact recognition mode.

FIG. 36 is a schematic block diagram illustrating a configuration of the display device of FIG. 25.

FIG. 37 is a flowchart illustrating a process of driving the display device of FIG. 25.

### MODES OF THE DISCLOSURE

Hereinafter, exemplary embodiments of the present disclosure will be described in detail with reference to the accompanying drawings in order to enable one of ordinary skill in the art to which the present disclosure pertains to easily embody the disclosure. The present disclosure may be implemented in various different forms and is not limited to embodiments described herein. To clearly describe the present disclosure, parts unrelated to the description have been omitted from the drawings, and like reference numerals are given to like or similar elements throughout. Because a size and a thickness of each element illustrated in the drawings are arbitrarily shown for convenience of description, the present disclosure is not necessarily limited to what is illustrated in the drawings.

In the present disclosure, being “on-” signifies being disposed above or below a target member and does not necessarily mean being disposed on an upper portion based on the direction of gravity. Also, throughout the specification, when it is said that a certain part “includes” a certain element, it signifies that the part may further include another element instead of excluding another element unless clearly indicated otherwise in the context.

Also, throughout the specification, when it is said that a certain part is “connected” to another part, it includes a case in which the part is “indirectly connected” to the other part while another member is interposed therebetween as well as a case in which the part is “directly connected” to the other part.

In the present specification, “touch recognition” refers to a function of recognizing an object which comes into contact with a surface and should be understood as having a comprehensive meaning which includes recognizing a fingerprint or a touch made by a person's finger as well as recognizing a touch made by a touch generator different from the above.

Hereinafter, embodiments of the present disclosure will be described in detail with reference to the accompanying drawings.

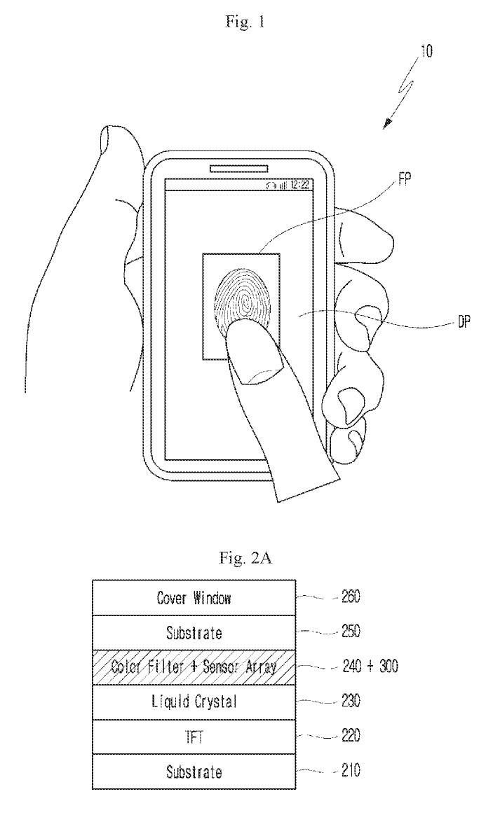

FIG. 1 is a view illustrating an exterior of an electronic device according to an embodiment of the present disclosure.

Referring to FIG. 1, an electronic device 10 according to an embodiment includes a display device DP.

The electronic device 10 may be a digital device including wired and wireless communication functions or a function other than the above. For example, the electronic device 10 is a digital device, such as a mobile phone, a navigation, a web pad, a personal digital assistant (PDA), a work station, and a PC (e.g., a laptop computer), having a memory and including a microprocessor embedded therein to have a calculating ability. Although description will be given by assuming that the electronic device 10 is preferably a smartphone as an example, the electronic device 10 is not necessarily limited thereto.

The display device DP may be formed at one surface of the electronic device 10. Preferably, as illustrated in FIG. 1, the display device DP may be implemented as a touch screen panel formed at a front surface of the electronic device 10 to also simultaneously serve as an input device.

According to an embodiment of the present disclosure, the display device DP performs a function of recognizing a fingerprint of a finger as well as finding out whether a touch generator (e.g., a finger) is in contact and a contact position.

Specifically, the display device DP may serve as a touchscreen for driving a specific function when a first application is run, and a fingerprint recognition function may be realized in an area of a fingerprint input window FP which is displayed on the display device DP or an entire area of the display device DP when a second application is run.

As will be described below, a touch by a touch generator or contact with ridges and valleys of a fingerprint of a finger is performed by a plurality of rows and columns of sensors. Contact with ridges and contact with valleys should be able to be differentiated to recognize a fingerprint of a finger. Consequently, a touch-sensing resolution related to the number of sensors included in the display device DP should be sufficiently high so that contact with ridges of a fingerprint of a finger and contact with valleys thereof can be differentiated.

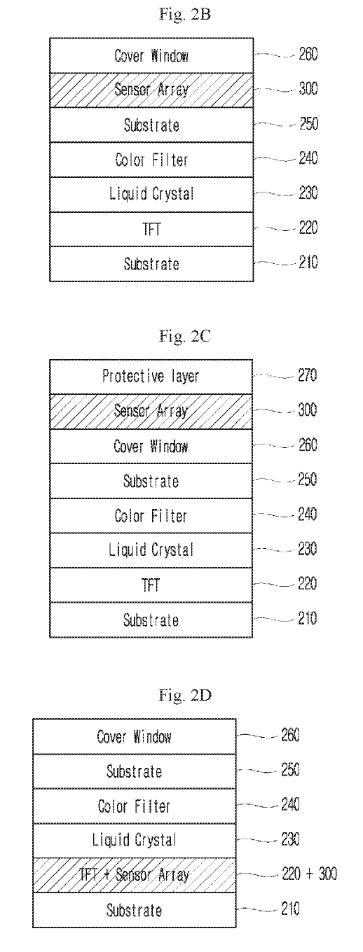

FIGS. 2A to 2D are cross-sectional views illustrating a configuration of a display device having an image sensing function according to an embodiment of the present disclosure. In FIGS. 2A to 2D, a configuration in which an image sensing function is integrated with a liquid crystal display (LCD) is illustrated as an example.

Referring to FIGS. 2A to 2D, an LCD includes a first substrate 210, a thin film transistor layer 220, a liquid crystal layer 230, a color filter layer 240, a second substrate 250, and a cover window 260 sequentially laminated in that order.

The LCD operates by a principle in which light radiated from a backlight unit (BLU) disposed below the first substrate 210 penetrates through the liquid crystal layer 230 and then passes through the color filter layer 240, which extracts color in pixel units to realize color, to realize desired color and image. The thin film transistor layer 220 serves to transmit or control an electrical signal, and a molecular structure of liquid crystal present in the liquid crystal layer 230 varies depending on an applied electrical signal to control penetration of light.

A sensor array layer 300 which senses a touch by a touch generator or performs a fingerprint recognition function, i.e., an image sensing function, according to an embodiment of the present disclosure may be disposed in a partial area of the LCD.

First, as illustrated in FIG. 2A, the sensor array layer 300 according to an embodiment may be arranged near the color filter layer 240. In this case, the sensor array layer 300 may be arranged in a lower area of the color filter layer 240 or in a region between the color filter layer 240 and the second substrate 250.

Next, as illustrated in FIG. 2B, the sensor array layer 300 according to an embodiment may be arranged between the second substrate 250 and the cover window 260. As illustrated in FIG. 2C, the sensor array layer 300 may be arranged above the cover window 260 for protecting the display device

When the sensor array layer 300 is arranged above the cover window 260 as illustrated in FIG. 2C, a separate protective layer 270 for protecting the sensor array layer 300 should be further formed above the sensor array layer 300.

Meanwhile, as illustrated in FIG. 2D, the sensor array layer 300 according to an embodiment may be formed on the same layer as the thin film transistor layer 220 on which circuits for driving the display device are realized.

Although description has been given above by assuming that the display device is implemented as, for example, the LCD, the display device may also be implemented as other types of display devices such as an organic light emitting diode (OLED) display device or an electrophoretic display (EPD).

The OLED display device is formed in a structure in which an OLED element having an electrode layer formed at both surfaces is arranged on a substrate. In this case, the sensor array layer 300 which performs the image sensing function according to an embodiment of the present disclosure may be formed above the substrate or above the OLED element.

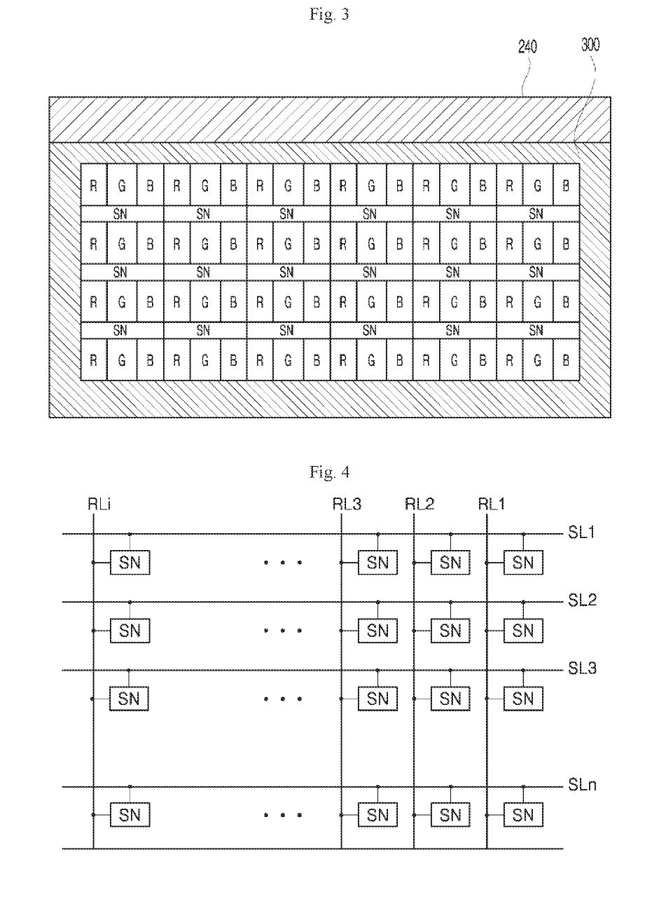

FIG. 3 is a plan view illustrating a configuration of a display device according to an embodiment of the present disclosure.

The color filter layer 240 and the sensor array layer 300 are illustrated in FIG. 3. As described above, the sensor array layer 300 may be formed relatively above or below the color filter layer 240.

A sensor array including a plurality of touch sensors may be formed at a front surface of a display according to an embodiment and may also be formed in a partial area of the display according to another embodiment. When the sensor array is formed in the partial area of the display, an area without a touch sensor may be configured so that, by a passivation (not illustrated), a height difference does not exist between the area without a touch sensor and the area in which touch sensors are present.

A plurality of touch sensors SN are disposed in the sensor array layer 300. The touch sensors SN may be implemented as capacitance type sensors including a plurality of transistors.

The color filter layer 240 may be formed by including a red pixel R for displaying a red image, a green pixel G for displaying a green image, and a blue pixel B for displaying a blue image. A single red pixel R, a single green pixel G, and a single blue pixel B form one pixel unit, and pixel units may be described as being formed in a matrix shape formed of a plurality of rows and columns. Accordingly, a touch sensor SN may be disposed for each pixel unit.

According to an embodiment, the touch sensors SN may be formed on the sensor array layer 300, sensing circuits of the touch sensors SN (e.g., transistors and wires) may be disposed in an area which does not overlap the red pixel R, the green pixel G, and the blue pixel B of the color filter layer 240 as seen from the top view, and sensing electrodes of the touch sensors SN may be disposed as a transparent electrode material such as indium tin oxide (ITO) in an area which overlaps at least a portion of the color pixel R, G, or B or in a portion of an area which does not overlap the color pixels. Although the touch sensors SN are illustrated in FIG. 3 as being disposed below the pixel units, the touch sensors SN may also be disposed above or beside the pixel units. Also, a size of one of the red pixel R, the green pixel G, and the blue pixel B may be relatively reduced to locate a sensing circuit of the touch sensor SN at the corresponding position.

According to another embodiment, when a transparent electrode material for transistors and wires is used in the touch sensor SN, the sensing circuit as well as the sensing electrode may be formed to overlap the red pixel R, the green pixel G, and the blue pixel B of the color filter layer 240 in the sensor array layer 300. Accordingly, because the touch sensor SN may be formed to overlap a pixel unit, two or more touch sensors SN may be disposed for each pixel unit and increase an image sensing resolution, or an image sensing sensitivity may be improved by forming a unit touch sensor SN to have a large size.

FIG. 4 is a view illustrating a configuration of the sensor array layer 300 which realizes the image sensing function according to an embodiment of the present disclosure.

Referring to FIG. 4, the sensor array layer 300 includes a plurality of scan lines SL1, SL2, . . . , SLn and a plurality of readout lines RL1, RL2, . . . , RLI. Scan signals are sequentially supplied to the plurality of scan lines SL1, SL2, . . . , SLn, and the plurality of readout lines RL1, RL2, . . . , RLI receive signals output from the touch sensors SN and transmit the received signals to a readout circuit (not illustrated).

According to an embodiment, the scan signals supplied to the plurality of scan lines may be supplied from a scan driver disposed in the sensor array layer 300.

The scan lines SL1, SL2, . . . , SLn and the readout lines RL1, RL2, . . . , RLI are disposed to cross each other, and at least one touch sensor SN may be formed at every intersection point.

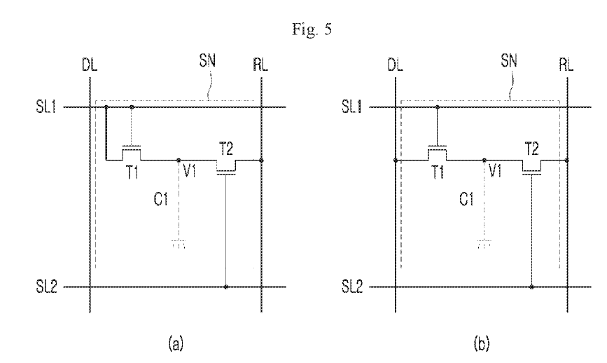

FIG. 5 is a circuit diagram illustrating a comparative example of the touch sensor SN disposed on the sensor array 300.

Referring to FIG. 5, the touch sensor SN may include a sensing electrode (not illustrated), a switching transistor T1, and a sensing transistor T2, and a touch capacitance C1 may be formed when a contact means comes into contact with the sensing electrode.

A gate electrode and a drain electrode of the switching transistor T1 in (a) of FIG. 5 are connected to the first scan line SL, and a source electrode thereof is connected to a node on which the touch capacitance C1 is formed. Meanwhile, a drain electrode of the sensing transistor T2 is connected to the readout line RL, a source electrode thereof is connected to the source electrode of the switching transistor T1, and a gate electrode thereof is connected to the second scan line S2.

When (b) of FIG. 5 is compared with (a) of FIG. 5, a difference exists in that the drain electrode of the switching transistor T1 is connected to a data line DL instead of the first scan line.

When a selection signal of the first scan line SL1 is supplied to the gate electrode of the switching transistor T1, the switching transistor T1 is turned on and the touch capacitance C1 is charged. When the selection signal is applied to the second scan line SL2, the sensing transistor T2 is turned on as a result, and the charge charged in the touch capacitance C1 may be shared by the touch capacitance C1 and a parasitic capacitance of the readout line RL.

Specifically, a large touch capacitance C1 is formed between the contact means and the touch sensor SN when the contact means approaches the touch sensor SN, and the size of the touch capacitance C1 is decreased when the contact means moves away from the touch sensor SN.

Then, a signal voltage of the readout line RL may be transmitted to a separate integrated circuit (IC) chip, and by the transmitted signal voltage, whether a screen is touched at a corresponding pixel and a contact area may be determined. In other words, the readout line RL senses a signal corresponding to an amount of charge which is charged in the touch sensor SN through a voltage, and whether a touch is generated and a contact state may be determined from the size of the voltage sensed above.

In the system illustrated in FIG. 5, a charge stored in the touch capacitance C1 is transmitted to the readout line RL through the sensing transistor T2. In the touch sensor SN, presence of a parasitic capacitance is inevitable due to relations with circuit configurations or other elements near the touch capacitance C1, the sensing transistor T2, and the readout line RL. Consequently, because the touch sensor SN senses a voltage by sharing a charge between the touch capacitance C1 and the parasitic capacitance of the readout line RL, the parasitic capacitance of the readout line RL is relatively higher than the touch capacitance C1, and there is a disadvantage in that a sensed voltage is significantly decreased.

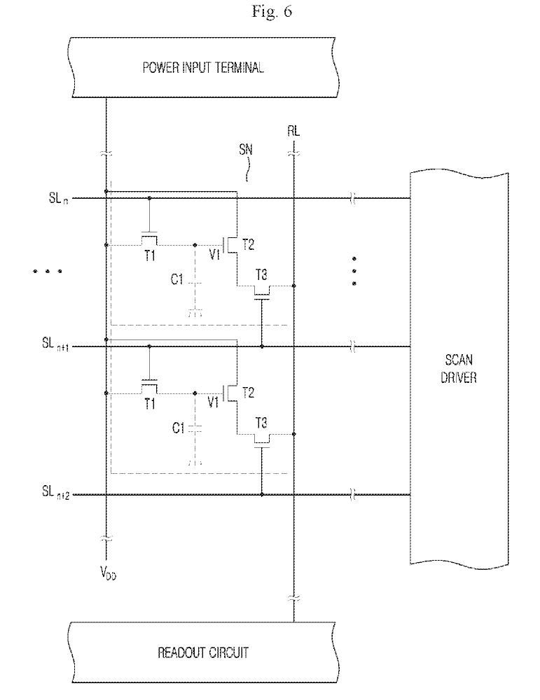

FIG. 6 is an equivalent circuit diagram illustrating a configuration of a capacitance type touch sensor capable of being applied to the display device according to an embodiment of the present disclosure.

Referring to FIG. 6, the touch sensor SN according to an embodiment of the present disclosure is disposed on at least a portion of the pixel unit formed on the sensor array 300 described with reference to FIG. 3.

Each of the touch sensors SN may be formed by including a sensing electrode and three transistors, and the three transistors may include a reset transistor T1, an amplifying transistor T2, and a read transistor T3. Each of the transistors T1 to T3 may be implemented with a silicon-based transistor such as a hydrogenated amorphous silicon (a-Si:H) transistor, a polysilicon (Poly-Si) transistor, and an oxide transistor or an organic compound transistor such as an organic thin film transistor which forms a channel area with an organic material. Each of the transistors T1 to T3 may be implemented with a thin film transistor structure which is coplanar, staggered, inverted coplanar, or inverted staggered.

In one embodiment, each of the transistors T1 to T3 may be formed of a transparent thin film transistor (TTFT). The TTFT has a characteristic of allowing a wavelength in a visible light range to pass therethrough. Accordingly, the TTFT may ensure visibility even when coupled to a display device.

The reset transistor T1 constantly resets a residual charge of a sensing electrode connected to the amplifying transistor T2 when a signal of a scan line SLn is applied.

A gate electrode of the reset transistor T1 may be connected to the scan line SLn, a source electrode thereof may be connected to a power input terminal Vdd, and a drain electrode thereof may be connected to the sensing electrode.

By receiving a voltage V1 applied to the touch capacitance C1 generated between the contact means and the sensing electrode via a gate electrode, the amplifying transistor T2 serves as an amplifier which transmits current signals as much as a change amount of the voltage V1 to the read transistor T3.

The gate electrode of the amplifying transistor T2 may be connected to the sensing electrode, a source electrode thereof may be connected to the power input terminal Vdd, and a drain electrode thereof may be connected to a drain electrode of the sensing transistor T3.

The read transistor T3 serves to selectively pass a current flowing in the amplifying transistor T2 to the readout line RL. By a selection signal applied from a scan line SLn+1 applied to a gate electrode, the read transistor T3 performs an operation of passing a current flowing in the amplifying transistor T2 to the readout line RL.

The gate electrode of the read transistor T3 may be connected to the scan line SLn+1, a drain electrode thereof may be connected to the drain electrode of the amplifying transistor T2, and a source electrode thereof may be connected to the readout line RL.

According to an embodiment, sensing electrodes are formed at a central portion of the pixel unit of the display illustrated in FIG. 2. When each of the transistors T1 to T3 is formed of an opaque or semi-transparent electrode material, the sensing electrodes may be disposed in an area which does not overlap an electrode edge or a color filter to ensure visibility of the display.

According to another embodiment, when each of the transistors T1 to T3 is formed of a transparent electrode material, the sensing electrodes may be disposed in an area which overlaps the color filter.

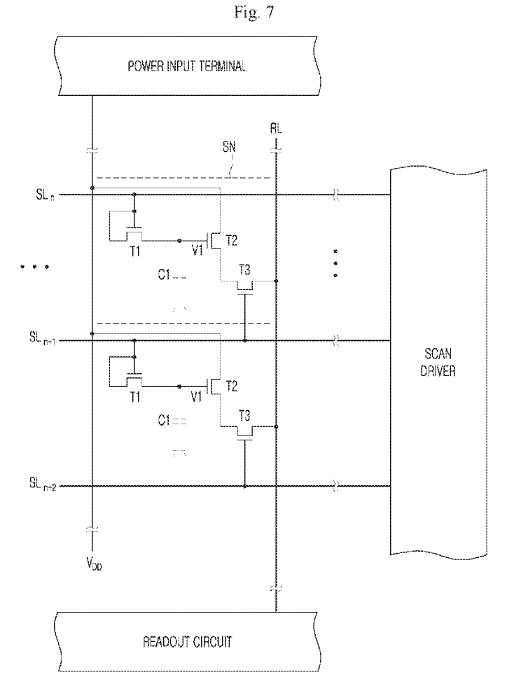

FIGS. 7 to 9 are equivalent circuit diagrams illustrating a configuration of a capacitance type touch sensor according to another embodiment of the present disclosure.

Referring to FIG. 7, a connection state of only the reset transistor T1 may be changed from the configuration of the touch sensor SN disclosed in FIG. 6. Specifically, the source electrode of the reset transistor T1 may be connected to the gate electrode instead of the power input terminal Vdd. Accordingly, when a selection signal is applied from the scan line SLn to the gate electrode, the same selection signal may also be applied to the source electrode, and a separate power input terminal may not be required to drive the touch sensor SN.

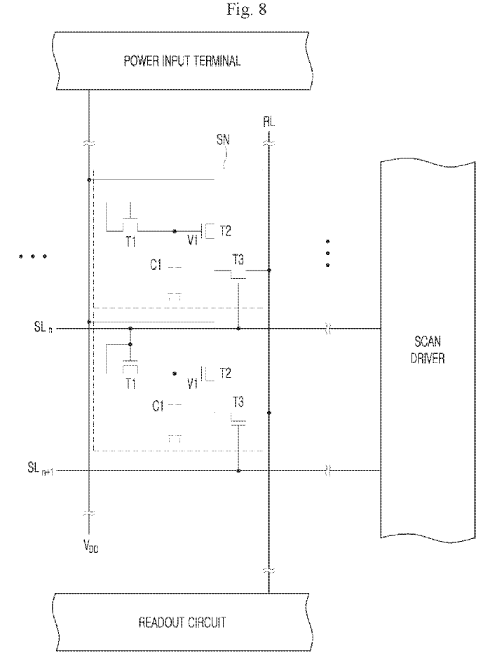

Referring to FIG. 8, a connection state of the reset transistor T1 may be changed from the configuration of the touch sensor SN disclosed in FIG. 7. Although the source electrode and the gate electrode of the reset transistor T1 are tied together and connected to the scan line SLn in the circuit of FIG. 7, the source electrode and the gate electrode may be tied together and connected to the power input terminal Vdd as in the circuit of FIG. 8. According to various embodiments, a power input terminal line to which the source electrode and the gate electrode of the reset transistor T1 are tied together and connected may be replaced by a data line to which a preset predetermined voltage is applied.

By configuring the circuit of the touch sensor SN as above, the number of scan lines SLn required for driving each of the touch sensors SN may be reduced. Although the number of scan lines SLn is only reduced by one altogether, because the number of scan lines required for each of the touch sensors SN to be driven is reduced from two to one, an operation of a scan driver can be simplified.

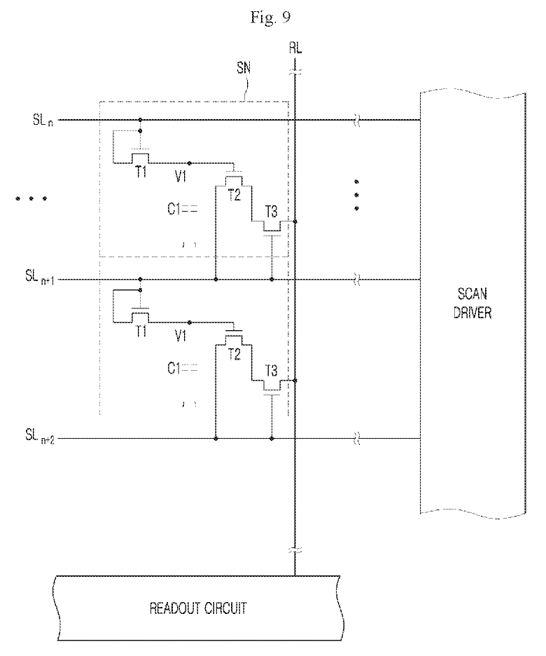

Referring to FIG. 9, in a circuit configuration of the touch sensor SN disclosed herein, the power input terminal Vdd may be removed, and the touch sensor SN may be driven only by the scan line SLn.

Specifically, the source electrode of the amplifying transistor T2 operates by receiving a voltage from the scan line SLn instead of the power input terminal Vdd. For this, the scan driver may be driven so that a signal is transmitted to the amplifying transistor T2 at an operation timing thereof.

In this way, by removing the power input terminal Vdd, the circuit configuration of the touch sensor SN may be further simplified in terms of design.

Meanwhile, in the equivalent circuit diagrams of the touch sensor SN disclosed in FIGS. 6 to 9, the power input terminal Vdd may be the data line L, and a voltage applied to the data line may be a data signal.

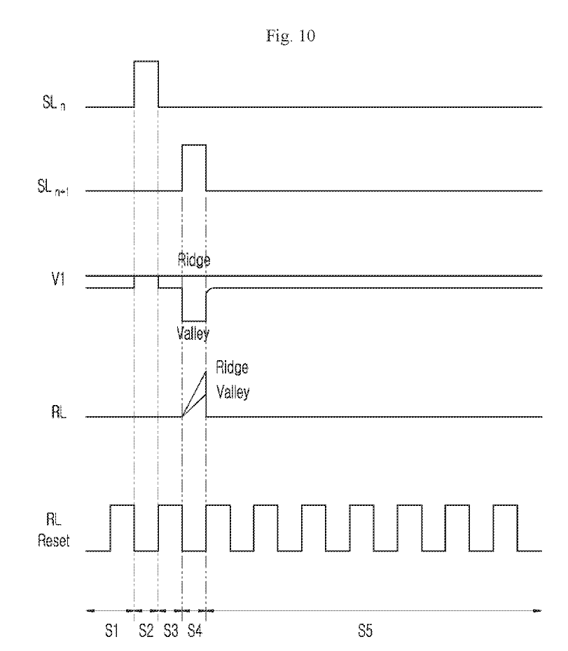

FIG. 10 is a timing diagram for describing an operation of the touch sensor SN according to an embodiment of the present disclosure.

An operation of the touch sensor SN according to an embodiment of the present disclosure will be described below with reference to FIGS. 6 to 10.

In FIG. 10, SLn and SLn+1 respectively represent signals supplied to corresponding scan lines SLn and SLn+1, and it should be understood that a selection signal is supplied to the scan lines SLn and SLn+1 during a high section. A specific touch sensor SN is selected by application of the selection signal, and a signal from another touch sensor SN is output. Hereinafter, SL refers to a scan line signal. Also, RL Reset is a signal for resetting the readout line RL. The readout line RL is reset as the reset signal is supplied to the high section.

Meanwhile, V1 represents a potential of the sensing electrode connected to the gate electrode of the amplifying transistor T2, i.e., a potential due to a charge which is charged in the touch capacitance C1 generated between the contact means and the sensing electrode. RL represents an amount of current detected from the readout line RL connected to the source electrode of the read transistor T3.

In the timing diagram of V1 and R1, the potential V1 according to an amount of charge charged in the touch capacitance C1 and a current of the readout line RL vary depending on whether ridges come into contact or valleys come into contact with an upper portion of the sensing transistor T1 of the touch sensor SN.

First, a case in which the touch sensor SN is not in contact with any contact means will be described. Because a contact means does not exist, the touch capacitance C1 formed between the sensing electrode and the contact means does not exist.

When a signal of scan line SLn connected to the gate electrode of the reset transistor T1 is converted to a high level (S2), the reset transistor T1 is turned on, a predetermined amount of charge is charged in the sensing electrode connected to the drain electrode of the reset transistor T1 by a voltage input through the power input terminal Vdd connected to the source electrode of the reset transistor T1, and the voltage V1 is increased.

The source electrode of the amplifying transistor T2 is also connected to the power input terminal Vdd and receives the input voltage. However, because a relation between the gate electrode V1 and the source electrode of the amplifying transistor T2 is designed to be unable to exceed a threshold voltage of the amplifying transistor T2 when valleys of a fingerprint come into contact with the touch sensor SN and the touch capacitance C1 is small, a current passed from the drain electrode of the amplifying transistor T2 to the read transistor T3 does not exist, and a current is not detected also from the readout line RL.

Next, a case in which valleys of a fingerprint of a finger come into contact with the touch sensor SN and a case in which ridges thereof come into contact will be separately described. The touch capacitance C1 is formed between the contact means and the touch sensor SN as valleys or ridges of a finger come into contact with the touch sensor SN. The touch capacitance C1 of a different size is formed in each of the case in which the valleys come into contact and the case in which ridges come into contact.

As a selection signal is applied to the scan line SLn connected to the gate electrode of the reset transistor T1 in the section S2, the reset transistor T1 is turned on, a signal from the power input terminal Vdd is transmitted through the drain electrode of the reset transistor T1, and the touch capacitance C1 is charged as a result.

The touch capacitance C1 varies according to a distance between a sensing electrode and a contact means. A size of the touch capacitance C1 is smaller in a case in which valleys of a fingerprint are in contact with the sensing electrode compared to a case in which ridges of the fingerprint are in contact with the sensing electrode.

The case in which valleys of a fingerprint of a finger come into contact with the sensing electrode will be described first. When a high signal is applied to the first scan line SLn (S2), the voltage V1 of the touch capacitance C1 is increased due to a current flowing from the source electrode of the reset transistor T1 to the drain electrode thereof. Then, when a high signal is applied to the second line SLn+1 (S4), as the read transistor T3 is turned on, a potential of the source electrode of the amplifying transistor T2 is dropped to 0, and the voltage V1 of the touch capacitance C1 is decreased due to coupling by a parasitic capacitance formed between the gate and the source of the amplifying transistor T2. Also, as a high signal in the second scan line SLn+1 is applied to the gate electrode of the read transistor T3, the read transistor T3 is turned on. When the read transistor T3 is turned on, a current flowing from the drain electrode of the amplifying transistor T2 flows to the source electrode through the drain electrode of the read transistor T3, and the current finally flows to the readout line RL. In this case, because the voltage V1 of the touch capacitance C1 is low, a current flowing in the readout line RL may be smaller compared to the case in which ridges come into contact.

The case in which ridges of a fingerprint of a finger come into contact with the sensing electrode will be described. When a high signal is applied to the first scan line SLn (S2), the voltage V1 of the touch capacitance C1 is increased. Here, because the touch capacitance C1 is formed to be relatively larger compared to the case in which valleys come into contact, the coupling due to the parasitic capacitance between the gate and the source of the amplifying transistor T2 does not occur. Consequently, the voltage V1 of the touch capacitance C1 can be constantly maintained in this case. Then, when a high signal is applied to the second scan line SLn+1 (S4), the read transistor T3 is turned on, and a current flowing from the drain electrode of the amplifying transistor T2 flows to the drain electrode through the source electrode of the read transistor T3. Also, although a current is detected from the readout line RL, because the coupling due to the parasitic capacitance does not occur and the potential of the gate electrode of the amplifying transistor T2 is constantly maintained, a larger amount of current flows compared to the case in which valleys come into contact.

Then, which of ridges and valleys of a fingerprint of a finger has come into contact with the sensing electrode, a contact area, etc. may be determined from variations patterns of a size of a current detected by the readout line RL.

In this way, according to an embodiment of the present disclosure, because a circuit is reset by the reset transistor T1 when a signal is applied to a scan line, there is an advantage in that a separate reset line is not required. In this way, according to the present disclosure, because a separate wire is not required other than a scan line, a circuit can be simply configured. Also, when a selection signal is applied to a scan line connected to the gate electrode of the read transistor T3, because a gate electrode of the reset transistor T1 of another touch sensor SN is also connected to the corresponding scan line, a single scan line can simultaneously control signal detection in the readout line RL included in one touch sensor SN and an operation of the sensing transistor T1 included in the other touch sensor SN.

According to an embodiment of the present disclosure, because the amplifying transistor T2 is operated according to a change in the touch capacitance C1, a disadvantage in that a signal detected from a charge sharing circuit is decreased can be improved.

Also, according to an embodiment of the present disclosure, by using a transparent thin film transistor and transparent electrodes and having an opening formed at a central portion of a sensing electrode, an aperture ratio of a display device can be improved.

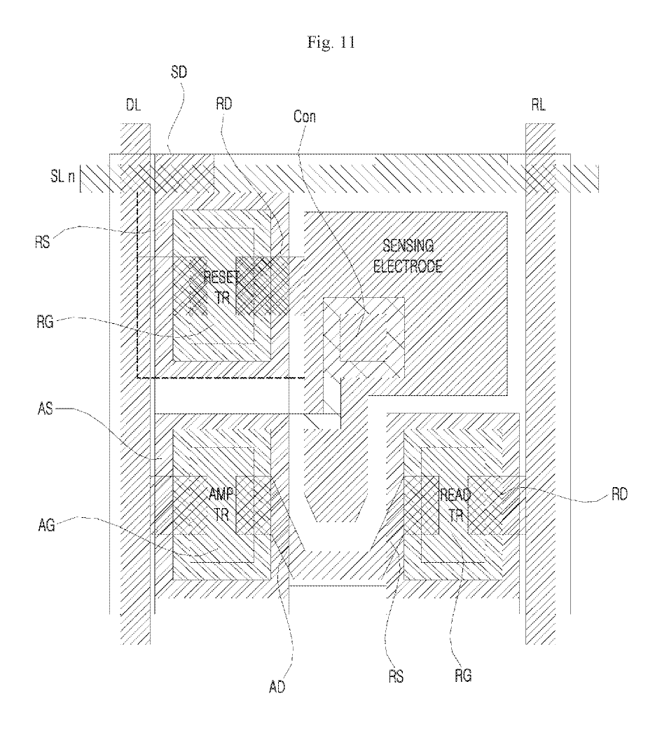

FIG. 11 is a plan view of a touch sensor according to an embodiment of the present disclosure.

Referring to FIGS. 6 and 11, T1, T2, and T3 correspond to a Reset TR illustrated at an upper left side of FIG. 10, an Amp TR illustrated in a lower left side thereof, and a Read TR illustrated in a lower right side thereof, respectively.

A gate electrode RG of the reset transistor T1 may be connected to the scan line SLn, the source electrode RS thereof may be connected to a power input terminal DL, and a drain electrode RD thereof may be connected to a sensing electrode.

A gate electrode AG of the amplifying transistor T2 may be connected to the sensing electrode through a contact Con, a source electrode AS thereof may be connected to the power input terminal DL, and a drain electrode AD thereof may be connected to a source electrode RS of the read transistor T3.

A gate electrode RG of the read transistor T3 may be connected to the scan line SLn+1, the source electrode RS thereof may be connected to the drain electrode AD of the amplifying transistor T2, and a drain electrode RD thereof may be connected to a readout line RL.

According to an embodiment, when the transistors T1 to T3 are implemented with an oxide transistor, because a characteristic of an oxide may be changed according to light incident thereto, the touch sensor may further include a shield electrode SD. The shield electrode SD may block outside light by being arranged to overlap the transistors T1 to T3 on the transistors T1 to T3.

Here, the touch capacitance C1 is formed between the contact means and the sensing electrode, and the voltage V1 applied to the touch capacitance C1 is input to the gate electrode AG of the amplifying transistor T2. Also, a current signal which is differently formed according to an amount of change of the voltage V1 input to the gate electrode AG of the amplifying transistor T2 may be transmitted to the read transistor T3.

Meanwhile, the size of the touch capacitance C1 is increased as the contact area between a finger and the sensing electrode is larger.

Consequently, to implement the transistors T1 to T3 and the sensing electrode together on the same plane as in the embodiment illustrated in FIG. 11, an area occupied by the transistors T1 to T3 may be maximally minimized, and an area occupied by the sensing electrode may be maximized.

According to still another embodiment, when light transmittance of one or more of a source electrode, a drain electrode, and a gate electrode for implementing the transistors T1 to T3 is low, the transistors T1 to T3 may be implemented in an area which does not overlap color pixels R, G, and B as illustrated in FIG. 2 or may also be implemented in an area overlapping the color pixels by configuring the sensing electrode with a transparent electrode. In this case, a fingerprint image can be scanned while visibility of a display is not degraded.

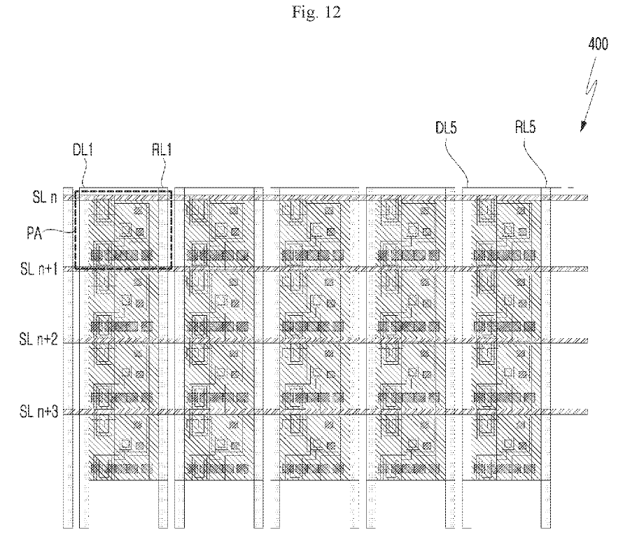

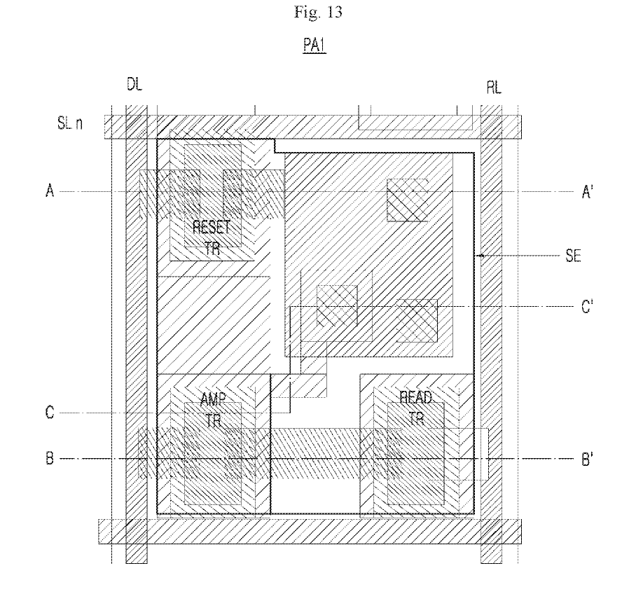

FIG. 12 is a view illustrating a plan view of a sensor array in which a plurality of touch sensors are arranged according to another embodiment of the present disclosure, and FIG. 13 is an enlarged plan view of a touch sensor in a pixel unit illustrated in FIG. 12.

Referring to FIG. 12, a sensor array 400 includes a plurality of touch sensors PA. Each touch sensor PA is connected to a single data line DL1, a single readout line RL, and two scan lines SLn and SLn+1. Although a 5×4 array is illustrated as an embodiment for convenience of description, the scope of the present disclosure is not limited thereto, and the sensor array 400 may be implemented as any M×N array (where M and N are natural numbers equal to or greater than 1).

The unit touch sensors of FIG. 12 will be described in more detail with reference to FIG. 13, which is an enlarged view thereof. A single unit touch sensor is connected to the data line DL, the readout line RL, and the scan line SL, and includes a Reset TR T1, an Amp TR T2, a Read TR T3, and a sensing electrode SE.

Because connection relations of each of the transistors are the same as those described with reference to FIG. 11, the description thereof will be omitted. A difference from FIG. 11 is that a front surface of a unit touch sensor PA is formed to overlap the sensing electrode SE without a shield electrode overlapping the transistors T1 to T3.

Here, the sensing electrode is connected to the drain electrode RD of the Reset TR T1 and the gate electrode AG of the Amp TR T2 through a contact.

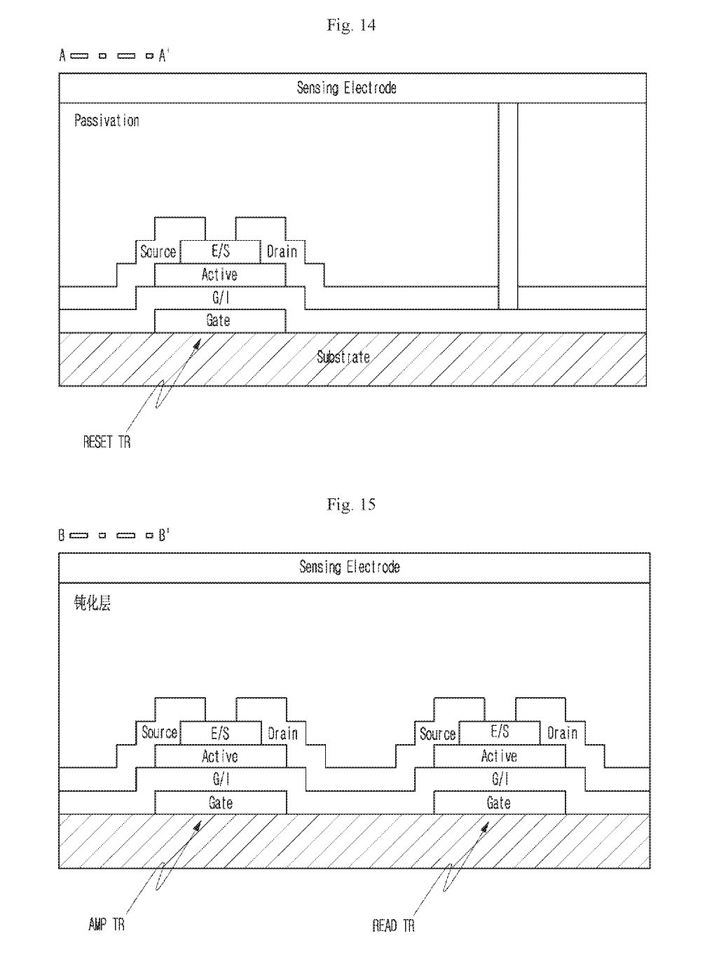

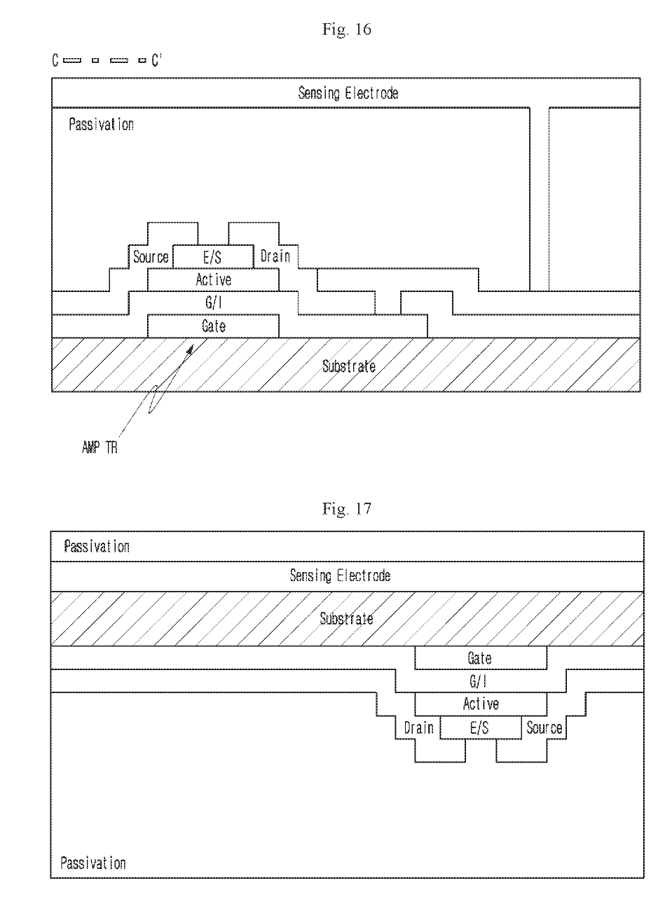

FIG. 14 is a cross-sectional view taken along line A-A′ of a touch sensor in a pixel unit illustrated in FIG. 12, FIG. 15 is a cross-sectional view taken along line B-B′ of a touch sensor in a pixel unit illustrated in FIG. 12, and FIG. 16 is a cross-sectional view taken along line C-C′ of a touch sensor in a pixel unit illustrated in FIG. 12.

Referring to FIGS. 14 to 16, each of the transistors forms a gate on a substrate and forms a gate insulating layer. After an active layer is formed on the gate insulating layer, source-drain electrodes are formed by patterning through a photolithography process.

Referring to FIG. 14, when the touch sensor is viewed from an A-A′ cross-section, the Reset TR T1 at the lower left side includes source-drain electrodes, a gate electrode, a gate insulating layer G/I, and an active layer Active. Here, a substrate may be formed of a material such as glass, a film, plastic PI, and stainless steel.

The source-drain electrodes or the gate electrode of the Reset TR T1 may be implemented with a single material or a composite material such as ITO, indium-zinc-oxide (IZO), molybdenum (Mo), aluminum (Al), copper (Cu), silver (Ag), and titanium (Ti). An active area between the source-drain electrodes may be implemented with an oxide-based material such as a-Si:H, low temperature polysilicon (LTPS), and indium-gallium-zinc-oxide (IGZO) or an organic material. The gate insulating layer G/I may be implemented with SiO₂, SiNₓ, etc.

The Reset TR T1 may further include an etch stopper. An etch stopper E/S may be implemented with a material such as SiO₂ and SiNₓ. The etch stopper protects an active layer which is already-formed by a chemical substance in the photolithography process for forming the source-drain electrodes to prevent damage to the active area.

In the touch sensor PA, a passivation layer for making a surface even may be formed before a sensing electrode is formed on the Reset TR T1. The passivation may be implemented with a transparent material such as thin-glass, SiO₂ and SiN_{Ω}.

As described with reference to FIG. 12, the Rest TR T1 has the drain electrode RD connected to the sensing electrode SE. Here, because the sensing electrode SE is formed to overlap a front surface of a unit touch sensor as illustrated in FIGS. 11 and 12, the sensing electrode is connected to the drain electrode RD through a contact CON passing through the passivation. According to various embodiments, the sensing electrode SE may be implemented with a single material or a composite material having penetrability such as ITO, IZO, Mo, Al, Cu, Ag, and Ti.

Referring to FIG. 15, when the touch sensor is viewed from a B-B′ cross-section, the Amp TR T2 at a lower left side is formed on a substrate and includes source-drain electrodes, a gate electrode, a gate insulating layer G/I, and an active layer Active. Also, the Read TR T3 at a lower right side is formed on a substrate and includes source-drain electrodes, a gate electrode, a gate insulating layer G/I, and an active layer Active. Here, the substrate may be formed of a material such as glass, a film, plastic PI, and stainless steel.

Because the source-drain electrodes, the gate electrodes, the gate insulating layers G/I, and the active layers Active constituting the Amp TR T2 and the Read TR T3 are formed together with the process of forming the reset transistor, the Amp TR T2 and the Read TR T3 may be formed of a material same as that of the Reset TR TL.

The Amp TR T2 and the Read TR T3 may further include an etch stopper. The etch stopper E/S may be implemented with a material such as SiO₂ and SiN_{Ω}. The etch stopper protects an active layer which is already-formed by a chemical substance in the photolithography process for forming the source-drain electrodes to prevent damage to the active area.

In the touch sensor PA, a passivation layer for making a surface even may be formed before a sensing electrode is formed on the Reset TR T1, the Amp TR T2, and the Read TR T3. The passivation may be implemented with a transparent material such as thin-glass, SiO₂ and SiN_{Ω}.

Also, the gate electrode AG of the amplifying transistor is connected to the drain electrode RD of the reset transistor, and as illustrated in FIGS. 13 and 16, a sensing electrode overlapping the touch sensor is connected to the gate electrode of the Amp TR.

When a surface of a contact means is scanned by the touch sensor according to the present embodiment, visibility of a display device can be ensured and image-sensing sensitivity can be improved by implementing a transparent electrode to have a larger area, and a size of a detection signal can be increased by using the coupling phenomenon due to a parasitic capacitance included in a transistor and a peripheral circuit configuration.

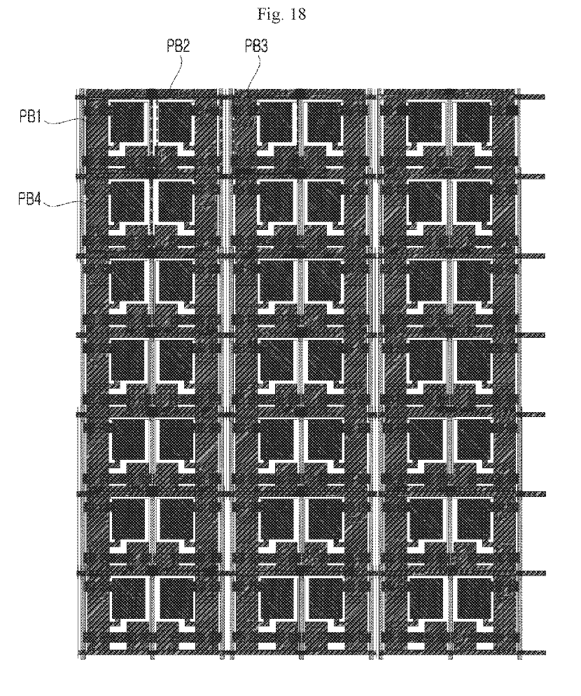

FIG. 17 is a view illustrating a side view of a touch sensor according to still another embodiment of the present disclosure. For convenience of description, a difference from FIG. 14 will be mainly described.

Referring to FIG. 17, each of the transistors T1 to T3 forms a gate on a substrate and forms a gate insulating layer. After an active layer is formed on the gate insulating layer, source-drain electrodes are formed by patterning through a photolithography process. Here, to protect an active layer, an etch stopper area may be further included before patterning the source-drain electrodes.

Unlike in FIG. 14, a sensing electrode may be formed at an opposite side of a substrate on which transistors are formed. Here, the sensing electrode is connected to a drain electrode of a reset transistor and a gate electrode of an amplifying transistor by boring a via hole on the substrate. The touch sensor according to the present embodiment may further include a passivation layer, i.e., a protective layer, on the sensing electrode to prevent the sensing electrode from being damaged due to contact with a contact means. Here, the passivation layer may be implemented with a transparent material such as thin-glass, ultra-thin glass, SiO₂ and SiN_{Ω}.

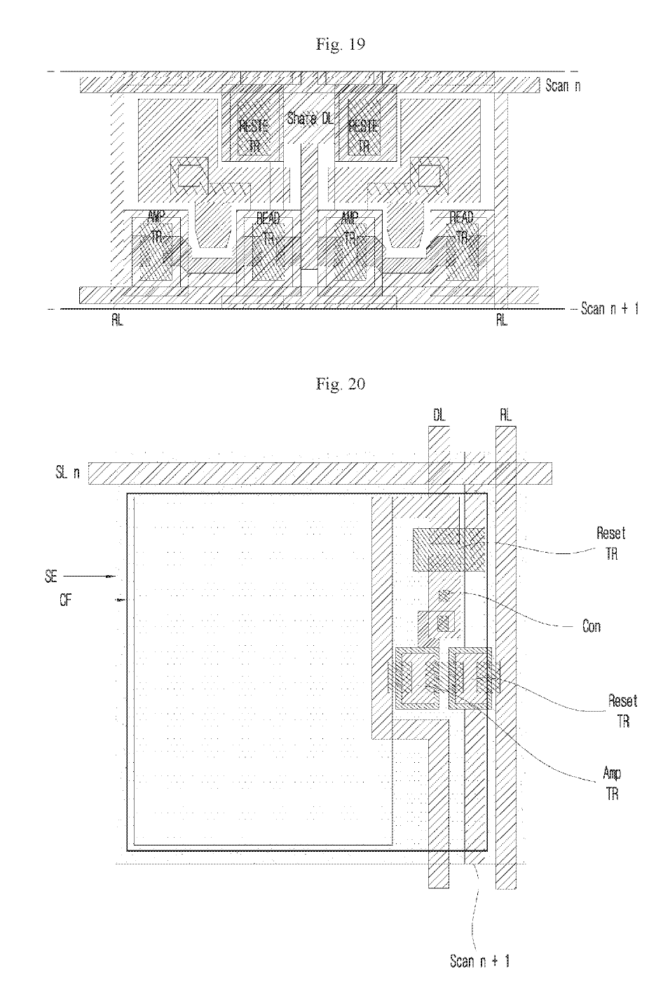

FIG. 18 is a plan view of a sensor array in which a plurality of touch sensors according to yet another embodiment of the present disclosure are arranged, and FIG. 19 is an enlarged plan view of the touch sensor in a pixel unit illustrated in FIG. 18.

Referring to FIG. 18, a sensor array includes a plurality of touch sensors PB. However, unlike in the embodiment illustrated in FIG. 12, the touch sensors PB are arranged to be symmetrical to other touch sensors in one direction.

In more detail, a first touch sensor PB1 to a third touch sensor PB3 are arranged in parallel in one direction, i.e., in a row direction. The first touch sensor PB1 and the second touch sensor PB2 are symmetrical to each other with respect a side at which the two come into contact, i.e., the readout line RL or the data line DL. Likewise, the second touch sensor TB2 and the third touch sensor PB3 are symmetrical to each other with respect to a side at which the two come into contact.

Meanwhile, adjacent touch sensors are not arranged to be symmetrical to each other in the other direction, i.e., a column direction. The first touch sensor PB1 is not arranged to be symmetrical to a fourth touch sensor PB4 with respect to a side coming into contact with the fourth touch sensor PB4, i.e., the scan line.

Referring to FIG. 19, a pair of touch sensors arranged in one direction are symmetrical to each other with respect to the data line DL. That is, reset transistors, amplifying transistors, read transistors, sensing electrodes, and signal lines DL, RL, and SL are arranged to be symmetrical to each other.

When adjacent touch sensors are arranged to be symmetrical to each other, although a data line may be separately arranged for each touch sensor according to an embodiment, a single data line, which becomes a reference line for symmetry, may be shared by two adjacent touch sensors according to another embodiment. As a result, because the number of signal wires is reduced and an aperture ratio of a touch sensor is increased per a pixel unit of a display, visibility of the display can be improved.

FIG. 20 is a plan view of a touch sensor according to yet another embodiment of the present disclosure.

Referring to FIG. 20, a touch sensor includes a reset transistor, an amplifying transistor, a read transistor, a sensing electrode SE, and signals lines DL, RL, and SL.

The sensing electrode is formed between a drain electrode of the reset transistor and a gate electrode of the amplifying transistor through a contact on a plane different from that of the transistors. The sensing electrode may be independent from an adjacent touch sensor and formed to have a maximum area capable of covering an entire size of a unit touch sensor. Here, the sensing electrode may be implemented with a single material or a composite material having penetrability such as ITO, IZO, Mo, Al, Cu, Ag, and Ti.

As described with reference to FIG. 11 and subsequent drawings, in a case in which a source electrode, a drain electrode, or a gate electrode of a reset transistor, an amplifying transistor, and a read transistor are semi-transparent or opaque, when a touch sensor is formed to overlap a pixel unit of a display, an aperture ratio of a pixel of the display is lowered, and there is a concern that visibility of the display may be degraded.

As in the present embodiment, even when a source electrode, a drain electrode, or a gate electrode of at least one transistor is semi-transparent or opaque, the transistors T1 to T3 of the touch sensor may be disposed in a black matrix in a pixel of a display, i.e., in an area in which color pixels CF are not disposed.

Because the black matrix is an area in which driving elements for implementing a display are disposed and penetration of light is blocked, when transistors and signal wires of a touch sensor are formed in the black matrix, visibility of the display can be prevented from being degraded.

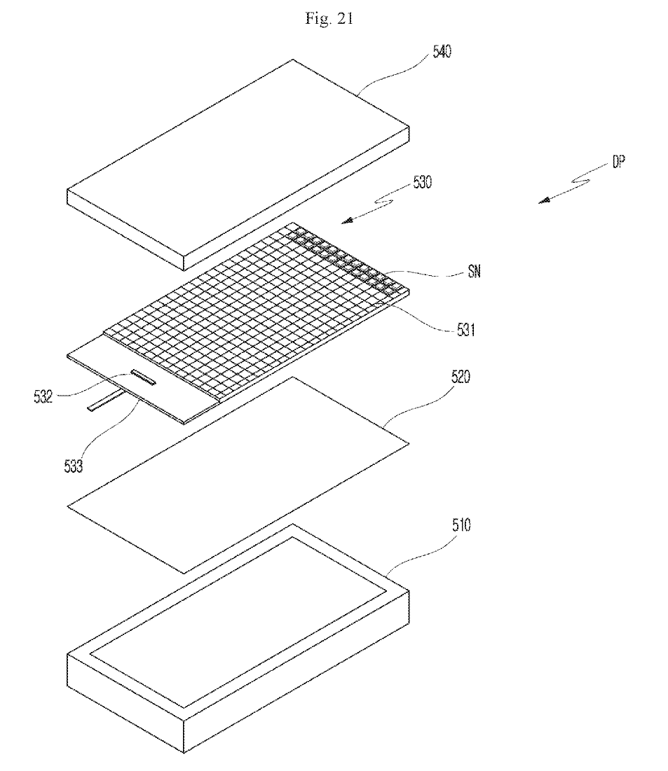

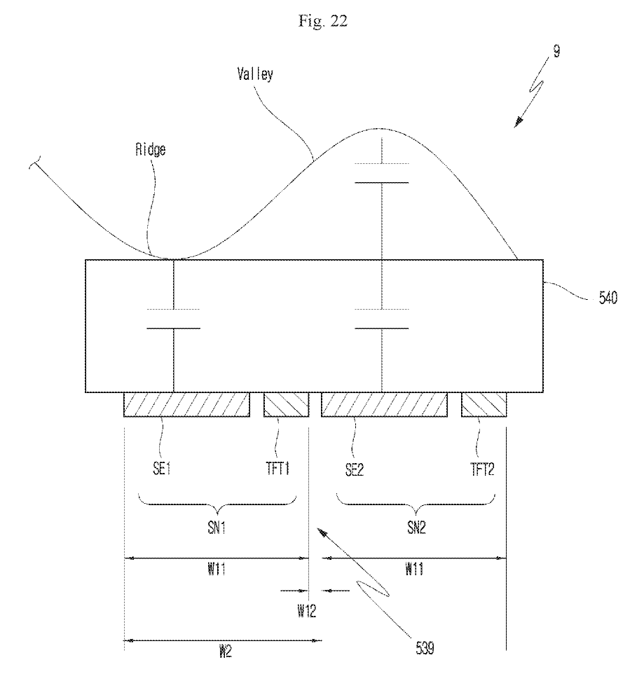

FIG. 21 is a schematic exploded perspective view of a display device including the touch sensor according to yet another embodiment of the present disclosure, and FIG. 22 is a view illustrating a schematic arrangement of touch sensors in the display device of FIG. 21.

Referring to FIGS. 21 and 22, a display device DP according to the present embodiment includes a display module 510, an adhesive layer 520, a touch sensor module 530, and a cover window 540.

A display area in which an image is displayed is formed in the display module 510. The display module 510 includes a plurality of pixel units disposed in the display area to display an image. For example, the display module 510 may be an OLED display module or an LCD display module.

A sensing area which overlaps the display area is formed in the touch sensor module 530. The touch sensor module 530 includes a transparent substrate 531, a plurality of touch sensors SN disposed at one surface of the transparent substrate 531, an integrated circuit package 532 configured to transmit a control signal to the touch sensors SN or receive a sensed signal from the touch sensors SN, and a flexible printed circuit board (FPCB) 533 configured to transmit the control signal to the integrated circuit package 532 from the outside.

Meanwhile, the pixel units of the display module 510 may overlap the touch sensors SN of the touch sensor module 530 in 1:1 relation. However, this is merely an illustrative arrangement configuration, and a configuration in which a plurality of touch sensors SN overlap a single pixel unit of the display module 510 is also possible.

Like the touch sensors SN disclosed in FIGS. 6 to 9, the touch sensors SN disposed in the display device DP according to the present embodiment may use a difference in capacitances of ridges and valleys of a user fingerprint 9 which comes into contact with the cover window 540 disposed above the touch sensor module 530 to scan an image of the user fingerprint 9.

Although the touch sensor SN according to the present disclosure is described as a configuration disposed on the transparent substrate 531 of the display module 510, a configuration in which the touch sensor SN is disposed at one surface of the cover window 540 without a separate transparent substrate 531 is also possible.

Among the plurality of touch sensors SN, a first touch sensor SN1 and a second touch sensor SN2 adjacent to the first touch sensor SN1 respectively include a first sensing electrode SE1 and a second sensing electrode SE2 configured to sense touch capacitances of the ridges and valleys of the user fingerprint 9, and a first thin film transistor part TFT1 and a second thin film transistor part TFT2 configured to provide a voltage to the first sensing electrode SE1 and the second sensing electrode SE2.

The first thin film transistor part TFT1 and the second thin film transistor part TFT2 may include at least one of the reset transistor, the amplifying transistor, and the read transistor of the touch sensor SN1 described with reference to FIGS. 6 to 9, and the first thin film transistor part TFT1 and the second thin film transistor part TFT2 may be disposed on the same plane as the first sensing electrode SE1 and the second sensing electrode SE2 and wires (not illustrated) configured to provide a signal.

Here, the first sensing electrode SE1, the second sensing electrode SE2, the first thin film transistor part TFT1, the second thin film transistor part TFT2, and the wires may be formed of a thin film made of a transparent material having a preset light transmittance, and may be formed of, for example, at least one material of ITO, a silver nano-wire, a carbon nano-tube (CNT), and IZO.

Meanwhile, a gap 539 may be formed between the first touch sensor SN1 and the second touch sensor SN2. An insulating material such as resin may be disposed in the gap 539 and insulate the first touch sensor SN1 and the second touch sensor SN2 from each other.

Here, the first touch sensor SN1 and the gap 539 forms a single sensing pitch, and a width W2 of a sensing pitch is equal to the sum of a width W11 of the first touch sensor SN1 and a width W12 of the gap 539.

To facilitate differentiating between the ridges and the valleys of the user fingerprint 9 having an interval of about 200 μm, the width W2 of the sensing pitch is formed as any one selected from 5 μm to 200 μm.

Meanwhile, because detailed configurations of the first sensing electrode SE1, the second sensing electrode SE2, the first thin film transistor part TFT1, the second thin film transistor part TFT2, and the wires are substantially the same as the configuration of the touch sensor SN described with reference to FIGS. 6 to 9, the detailed description thereof will be omitted.

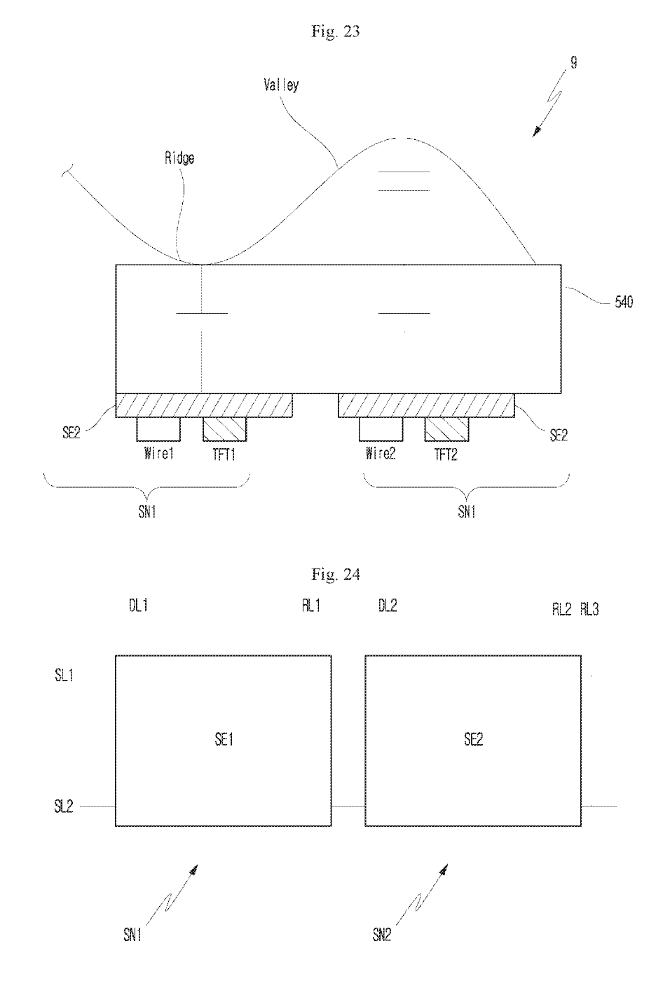

FIG. 23 is view illustrating a schematic arrangement of touch sensors according to yet another embodiment of the present disclosure, and FIG. 24 is a plan view of the touch sensors of FIG. 23.

Because the touch sensor SN according to the present embodiment is substantially the same as the configuration of the touch sensor SN of FIGS. 21 and 22 and is different therefrom only in terms an arrangement configuration of the touch sensor SN, features distinct to the present embodiment will be mainly described below.

Referring to FIGS. 23 and 24, the first sensing electrode SE1 and the second sensing electrode SE2 of the first touch sensor SN1 and the second touch sensor SN2 among the plurality of touch sensors SN according to the present embodiment are disposed below the cover window 540. The first thin film transistor part TFT1 and a first wire Wire1 are disposed below the first sensing electrode SE1 while overlapping the first sensing electrode SE1, and the second thin film transistor part TFT2 and a second wire Wire2 are disposed below the second sensing electrode SE2 while overlapping the second sensing electrode SE2.

The first thin film transistor part TFT1, the second thin film transistor part TFT2 may include at least one of the reset transistor, the amplifying transistor, and the read transistor of the touch sensor SN described with reference to FIGS. 6 to 9, and the first wire Wire1 and the second wire Wire2 may be at least one of a part of a scan line, a part of a data line, and a part of a readout line of the touch sensor SN described with reference to FIGS. 6 to 9. That is, the sensing electrodes SE1 and SE2 may be arranged in a shape which partially or entirely covers the reset transistor, the amplifying transistor, the read transistor, the part of the scan line, the part of the data line, and the part of the readout line.

The sensing electrodes SE1 and SE2, the reset transistor, the amplifying transistor, the read transistor, the scan line, the data line, and the readout line may be formed of a transparent conductive material such as IZO and ITO, and light generated from the display module 520 disposed below the touch sensor module 530 may pass through the touch sensors SN of the touch sensor module 530 and be projected to the outside.

According to the present embodiment, as the sensing electrodes SE1 and SE2 of the touch sensor SN are disposed above the transistor parts TFT1 and TFT2 and the wires Wire1 and Wire2, the sensing electrodes SE1 and SE2 may be formed to be larger, and because interference by parasitic capacitance formed in the transistor parts TFT1 and TFT2 and the wires Wire1 and Wire2 can be suppressed, there is an advantage in that touch-sensing sensitivity of a user fingerprint can be improved.

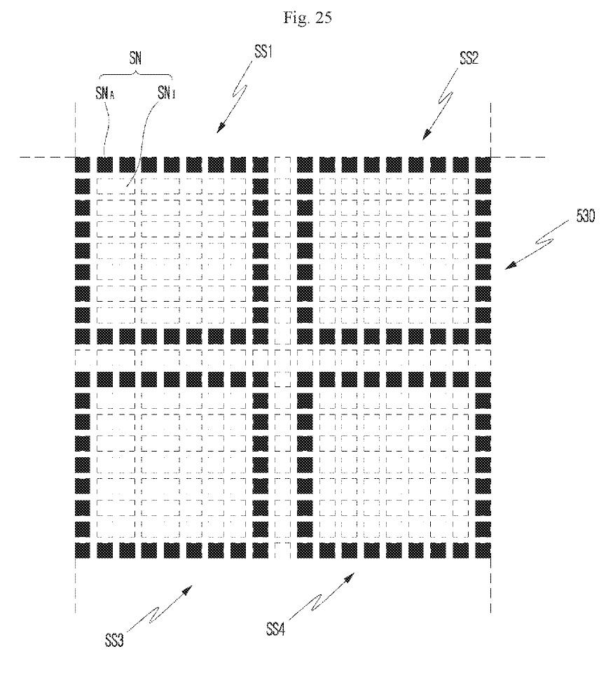

FIG. 25 is a view illustrating a state in which the display device including the touch sensors according to yet another embodiment of the present disclosure is driven in a touch recognition mode.

Because the display device including a touch sensor according to the present embodiment is substantially the same as the configuration of the display devices including a touch sensor described with reference to FIGS. 1 to 24 and is different therefrom only in terms a method of driving the touch sensor, features distinct to the present embodiment will be mainly described below.

Referring to FIG. 25, the touch sensor module 530 of a display device DP according to the present embodiment includes a plurality of touch sensor sectors SS1, SS2, SS3, and SS4 each including two or more touch sensors SN among a plurality of touch sensors SN.

When the touch sensor module 530 is driven in the touch recognition mode, some of the touch sensors SN of the touch sensors SN included in the plurality of touch sensor sectors SS1, SS2, SS3, and SS4 are selected and activated.

In the display device DP according to the present embodiment, the touch sensor module 530 is basically driven in the touch recognition mode. Because only some of the touch sensors SN are activated, power consumption can be decreased compared to a case in which all of the touch sensors SN are selected.

Here, the touch sensors SN becoming active, i.e., activated, refers to a state in which the touch sensors SN are selected by a scan signal and a data signal applied to the touch sensors SN, and the touch sensors SN can sense whether a contact means comes into contact with a surface of the display device DP.

In more detail, the touch sensor sectors SS1, SS2, SS3, and SS4 of the touch sensor module 530 according to the present embodiment each have a sensing area partitioned by overlapping a display area having pixel units of the display device DP to display an image, and include a plurality of touch sensors SN disposed in the partitioned area.

The touch sensor sectors SS1, SS2, SS3, and SS4 are formed in, for example, a quadrilateral shape. Touch sensors SN which are not included in any of the touch sensor sectors SS1, SS2, SS3, and SS4 are disposed between the touch sensor sectors SS1, SS2, SS3, and SS4 so that the touch sensor sectors SS1, SS2, SS3, and SS4 are spaced apart from each other by a width of at least one touch sensor SN.

When the touch sensor module 530 is driven in the touch recognition mode, some of the touch sensors SN of the touch sensors SN included in the touch sensor sectors SS1, SS2, SS3, and SS4 of the touch sensor module 530 are activated, and the activated touch sensors SN may sense whether a contact means, e.g., a user's finger, comes into contact with a surface of the display device DP and a contact position.

When the touch sensor module 530 according to the present embodiment is driven in the touch recognition mode, touch sensors SN_{A} activated in the touch sensor sectors SS1, SS2, SS3, and SS4 may be arranged at edge portions of the touch sensor sectors SS1, SS2, SS3, and SS4, and touch sensors SN_{I} disposed inside the edges remain inactivated.

Although the touch sensor sectors SS1, SS2, SS3, and SS4 of the touch sensor module 530 according to the present embodiment are illustratively described as being formed in a quadrilateral shape, a configuration in which the touch sensor sectors SS1, SS2, SS3, and SS4 are formed in a polygonal shape or a circular shape other than the quadrilateral shape is also possible.

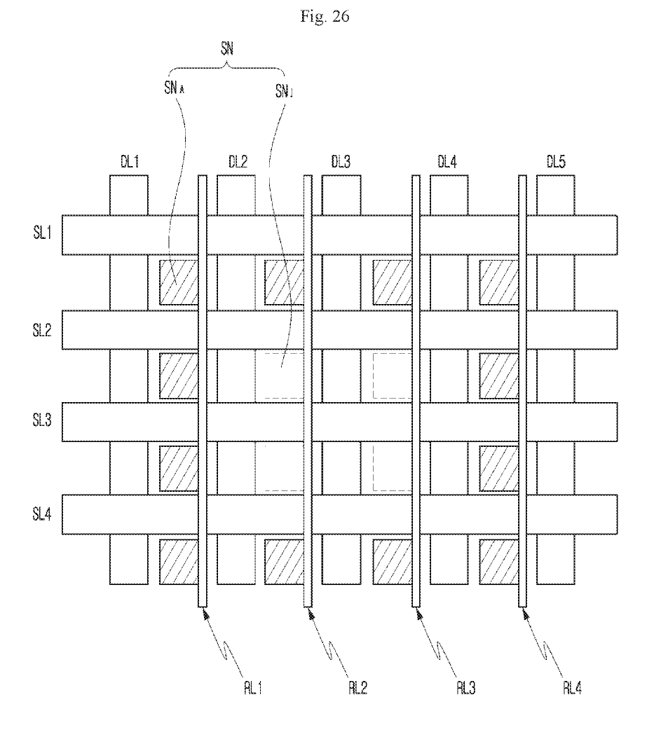

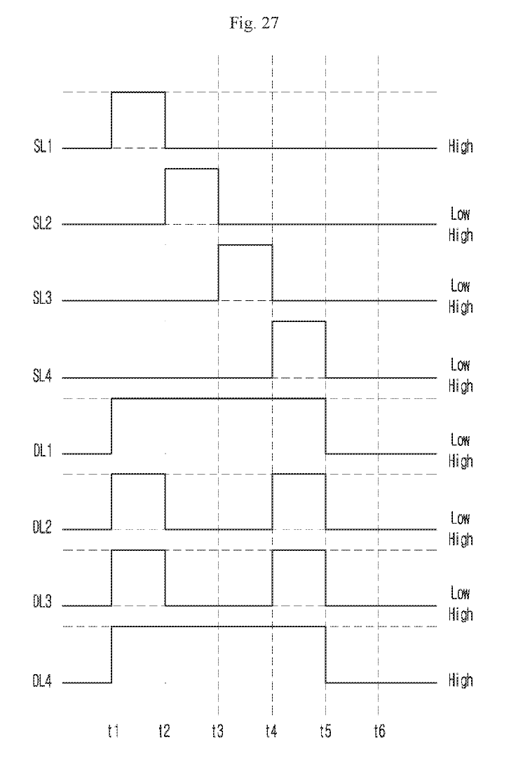

FIG. 26 is a view illustrating a driving state of a touch sensor array in the display device of FIG. 25, and FIG. 27 is a timing diagram for describing an operation of the touch sensors of FIG. 26.

Referring to FIGS. 26 and 27, a first data line DL1 to a fifth data line DL5 which provide a data signal to touch sensors SN are arranged in one direction, and a first scan line SL1 to a fourth scan line SL4 which provide a selection signal are arranged to intersect the first data line DL1 to the fifth data line DL5.

The touch sensors SN are respectively disposed at points at which the first data line DL1 to the fifth data line DL5 intersect the first scan line SL1 to the fourth scan line SL4. Here, it can be recognized that the power input line VDD of FIGS. 6 to 9 corresponds to the data line in FIG. 26. The power input line VDD or the data line is not limited to the term and refers to a line to which a constant voltage is applied.

Also, a first readout line RL1 to a fourth readout line RL4 are arranged parallel to the first data line DL1 to the fifth data line DL5 and are connected to each of the touch sensors SN. Readout signals, which are current signals corresponding to touch capacitances of the touch sensors SN, are detected from the first readout line RL1 to the fourth readout line RL4.

Here, scan signals applied to the first scan line SL to the fourth scan line SL4 are formed sequentially, i.e., in time-series, with each other. Data signals applied to the first data line DL1 to the fifth data line DL5 are independently formed from each other.

Hereinafter, a process in which the touch sensor module 530 is driven in the touch recognition mode, the touch sensors SN disposed at the edges of the touch sensor sectors SS1, SS2, SS3, and SS4 are activated, and the readout signals are detected from the activated touch sensors SN will be described in detail. A state in which the data signal, the scan signal, and the readout signal are applied or detected is referred to as being “High,” and a state in which the data signal, the scan signal, and the readout signal are not applied or detected is referred to as being “Low.”

First, a first scan signal is applied to the first scan line SL1 in an interval from a first reference time t1 to a second reference time t2. Here, a first data signal to a fourth data signal are input to the first data line DL1 to the fourth data line DL4, and all touch sensors SN_{A} disposed at points at which the first scan line SL1 intersects the first data line DL1 to the fourth data line DL4 are activated.

Then, a second scan signal is applied to the second scan line SL2 in an interval from the second reference time t2 to a third reference time t3. Here, the first data signal and the fourth data signal are respectively input to the first data line DL1 and the fourth data line DL4, and the data signal is not input to the second data line DL2 and the third data line DL3. Consequently, in the interval from the second reference time t2 to the third reference time t3, only the touch sensors SN_{A} arranged at points at which the second scan line SL2 intersects the first data line DL1 to the fourth data line DL4 are activated.

Then, a third scan signal is applied to a third scan line SL3 in an interval from the third reference time t3 to a fourth reference time t4. Here, the first data signal and the fourth data signal are respectively input to the first data line DL1 and the fourth data line DL4, and the data signal is not input to the second data line DL2 and the third data line DL3. Consequently, in the interval from the third reference time t3 to the fourth reference time t4, only the touch sensors SN_{A} arranged at points at which the third scan line SL3 intersects the first data line DL1 to the fourth data line DL4 are activated.

Then, a fourth scan signal is applied to the fourth scan line SL4 in an interval from the fourth reference time t4 to a fifth reference time t5. Here, the first data signal to the fourth data signal are input to the first data line DL1 to the fourth data line DL4, and all touch sensors SN_{A} disposed at and connected to points at which the fourth scan line SL4 intersects the first data line DL1 to the fourth data line DL4 are activated.

Consequently, from the first reference time t1 to the fifth reference time t5, the touch sensors SN_{A} arranged at the edges of the touch sensor sectors SS1, SS2, SS3, and SS4 are sequentially activated, and the touch sensors SN_{I} disposed inside the edges remain inactivated.

That is, the touch sensors SN_{A} to which both the scan signal and the data signal are applied among the touch sensors SN disposed in the touch sensor module 530 are activated, and the touch sensors SN_{I} to which any one of the scan signal and the data signal is not applied is not activated.

Meanwhile, when contact by the contact means is sensed by all of the touch sensors SN_{A} arranged at the edges of the touch sensor sectors SS1, SS2, SS3, and SS4, the readout signal is output through the first readout line RL1 to the fourth readout line RL4 connected to the touch sensors SN.

When the touch sensors SN according to the present embodiment are formed in an equivalent circuit configuration as in FIG. 6, a gate electrode of the read transistor included in the touch sensors SN is connected to a scan line next to a scan line to which the reset transistor of the touch sensors SN is connected.

That is, in a case of the touch sensor SN in which the reset transistor is connected to the first scan line SL1, the gate electrode of the read transistor of the touch sensor SN is connected to the second scan line SL2.

Consequently, a touch detection signal from a touch sensor SN activated during a certain reference time may be output during the next reference time.

For example, a touch detection signal from the touch sensor SN connected to the first scan line SL1 is output through the first readout line RL1 in the interval from the second reference time t2 to the third reference time t3 in which the second scan signal is applied is applied to the second scan line SL2.

Although it is described in the present embodiment that only the touch sensors SN_{A} disposed at the edges of the touch sensor sectors SS1, SS2, SS3, and SS4 are activated when the touch sensor module 530 is driven in the touch recognition mode, a configuration in which some of the touch sensors SN among the touch sensors SN disposed inside the edges of the touch sensor sectors SS1, SS2, SS3, and SS4 are randomly or regularly activated or only one touch sensor SN is activated per each of the touch sensor sectors SS1, SS2, SS3, and SS4 also belongs to the spirit of the present disclosure.

Also, although it is described in the present embodiment that the touch sensors SN included in each of the touch sensor sectors SS1, SS2, SS3, and SS4 are different from each other, a configuration in which the touch sensor sectors SS1, SS2, SS3, and SS4 share one or more touch sensors SN is also possible. In this case, the touch sensor sectors SS1, SS2, SS3, and SS4 may partially overlap each other.

Hereinafter, a process in which a contact position of a contact means is sensed when the plurality of touch sensor sectors SS1, SS2, SS3, and SS4 have simultaneously sensed a touch by the contact means will be described.

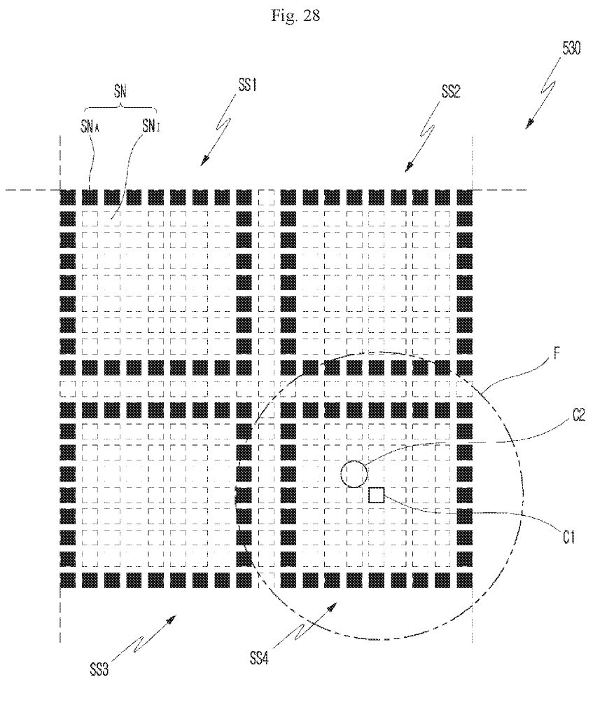

FIG. 28 is a view illustrating a state in which a contact means is in contact in the state of FIG. 25 in which the display device is driven in the touch recognition mode.

Referring to FIG. 28, for example, when a contact means such as a user's finger F simultaneously comes into contact with the plurality of touch sensor sectors SS1, SS2, SS3, and SS4, a display device DP according to the present embodiment determines a center of the touch sensor sector SS4 which includes the largest number of touch sensors SN_{A} of the touch sensors SN_{A} from which a touch is sensed, i.e., a center C1 of the fourth touch sensor sector SS4, as a touch point.

That is, the display device DP may count the number of the touch sensors SN_{A} from which a touch is sensed among the touch sensors SN_{A} included in the touch sensor sectors SS1, SS2, SS3, and SS4 and determine the center C1 of the touch sensor sectors SS1, SS2, SS3, and SS4 including the largest number of the touch sensors SN_{A} from which a touch is sensed as the touch point.

In another example, the display device DP may determine a calculated center C2 which is spaced apart, by a weighted average value of the number of touch sensors from which the contact is sensed included by each of the touch sensor sectors, from centers of the touch sensor sectors SS1, SS2, SS3, and SS4 including the touch sensors SN_{A} from which the contact is sensed as a touch point.

That is, the display device DP may calculate the calculated center C2 which is farthest from a center of the first touch sensor sector SS1, which includes the smallest number of the touch sensors SN_{A} from which a touch is sensed, and closest to the center of the fourth touch sensor sector SS4, which includes the largest number of the touch sensors SN_{A} from which a touch is sensed, and determine the calculated center C2 as the touch point.

According to the present embodiment, when only whether a user touches a surface of the display device DP is simply sensed, by activating only some of the touch sensors SN to sense a user's touch, there is an advantage in that power consumption of the display device DP can be minimized compared to when all touch sensors are activated.

FIGS. 29 to 31 are views illustrating a state in which a display device according to yet another embodiment of the present disclosure is driven in a touch recognition mode.

Because display devices according to the present embodiments are substantially the same as the configuration of the display devices described with reference to FIGS. 25 to 28 and are different therefrom only in terms of a configuration of a touch sensor sector, features distinct to the present embodiments will be mainly described below.

In a unit touch sensor sector SS, touch sensors may be activated and deactivated in various preset patterns according to recognition sensitivity and coordinate detection accuracy of a touch recognition mode. More specifically, referring to FIG. 29, the unit touch sensor sector SS of a display device DP according to the present embodiment includes activated touch sensors SN_{A} and inactivated touch sensors SN_{I} randomly arranged in an area of the touch sensor sector SS.

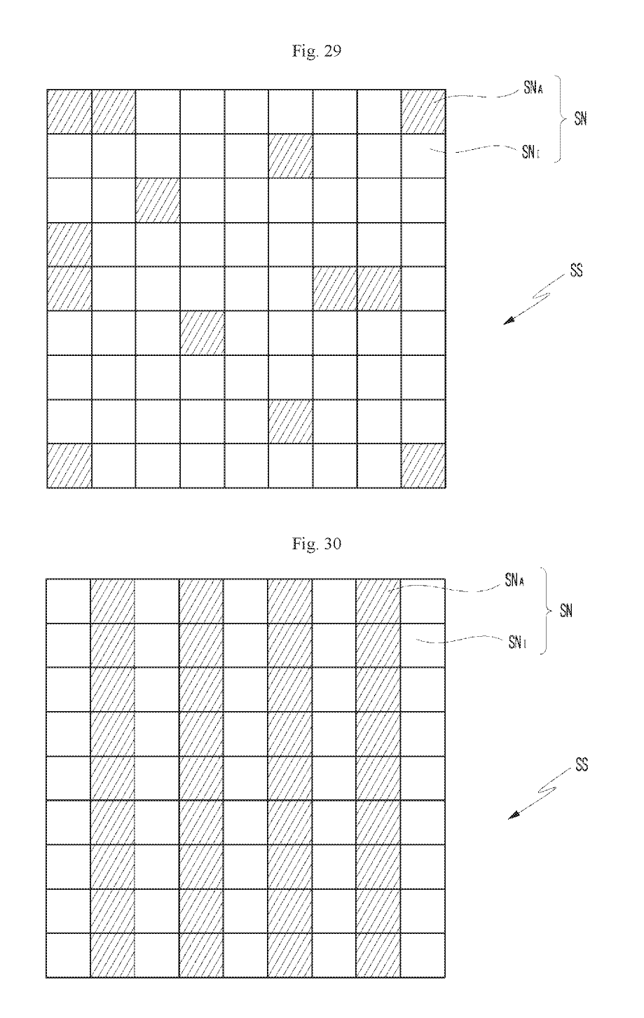

Then, referring to FIG. 30, the unit touch sensor sector SS includes activated touch sensors SN_{A} and inactivated touch sensors SN_{I} alternately arranged in a predetermined pattern in an area of the unit touch sensor sector SS.

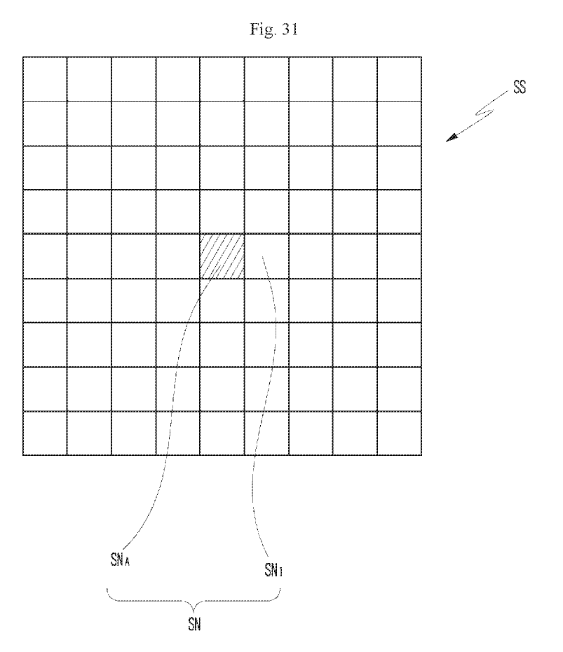

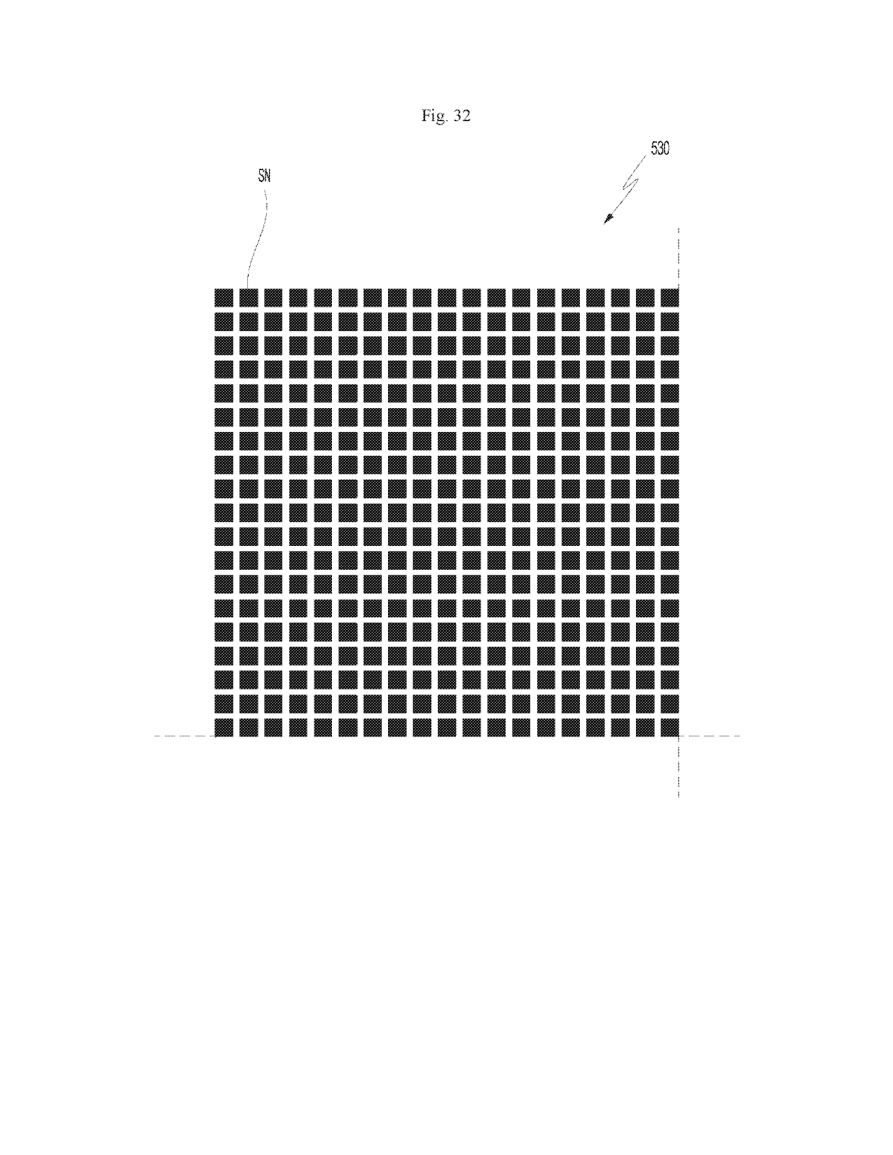

Then, referring to FIG. 31, the unit touch sensor sector SS includes at least one activated touch sensor SN_{A} arranged in an area of the unit touch sensor sector SS and inactivated touch sensors SN_{I} which surround the activated touch sensor SN_{A}. In the present embodiment, the activated touch sensor SN_{A} may be disposed at the center of the touch sensor sector SS.

FIG. 32 is a view illustrating a state in which the display device of FIG. 25 is driven in an entire fingerprint recognition mode.

Referring to FIG. 32, when the touch sensor module 530 of the display device DP according to the present embodiment is driven in the entire fingerprint recognition mode, all touch sensors SN included in the touch sensor module 530 are activated, and an image of a user fingerprint which touches a surface of the display device DP may be scanned.

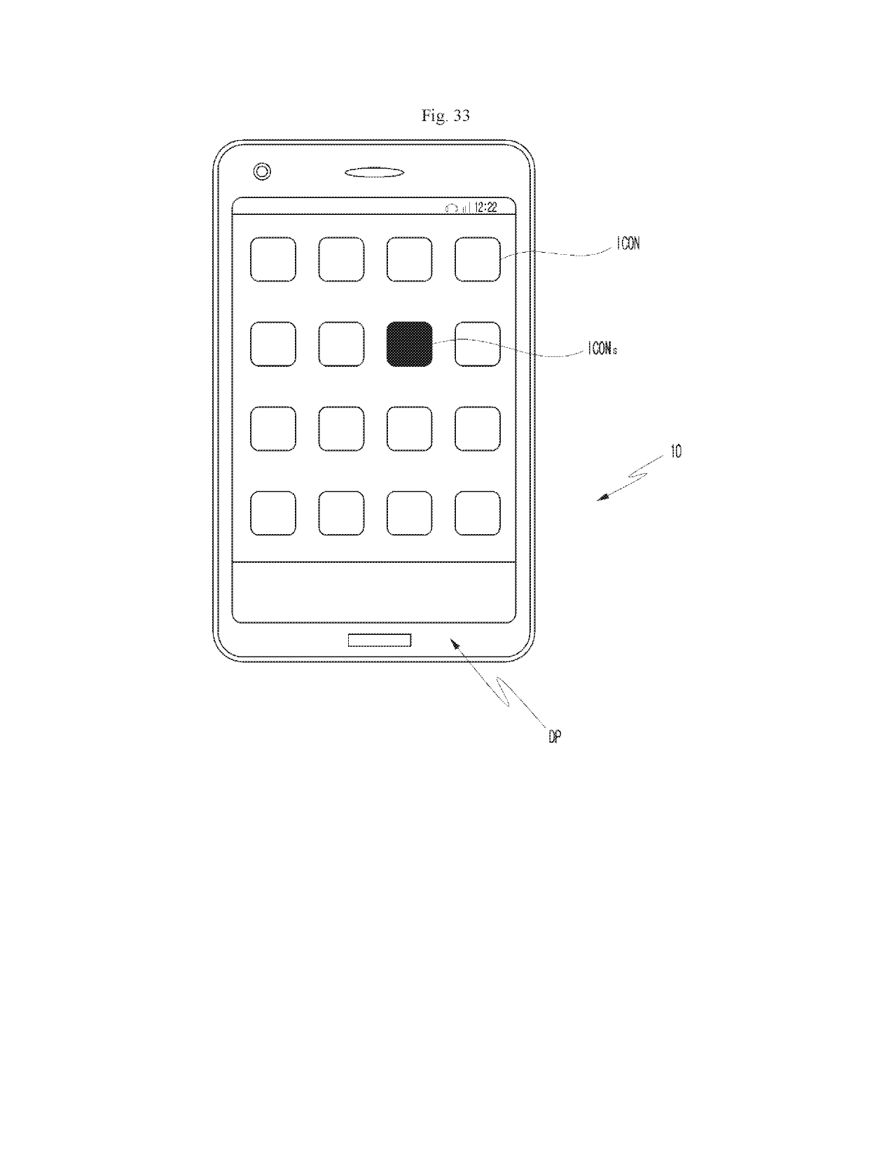

FIG. 33 is a view illustrating a state in which the display device of FIG. 25 is driven in an icon fingerprint recognition mode.

Referring to FIG. 33, in the icon fingerprint recognition mode of a display device DP, a plurality of touch sensors SN which overlap at least one icon ICONs of a plurality of icons ICON displayed on the display module 510 are selected.

That is, touch sensors SN which overlap a security icon ICONs, connected to a security application such as a mobile banking application, an application which requires biometric verification, and an application set by a user, among the plurality of icons ICON, may be selected and activated, and, in a process in which a user touches the security icon ICONs, an image of the user's fingerprint may be scanned to enable the security application to be run without a separate login procedure.

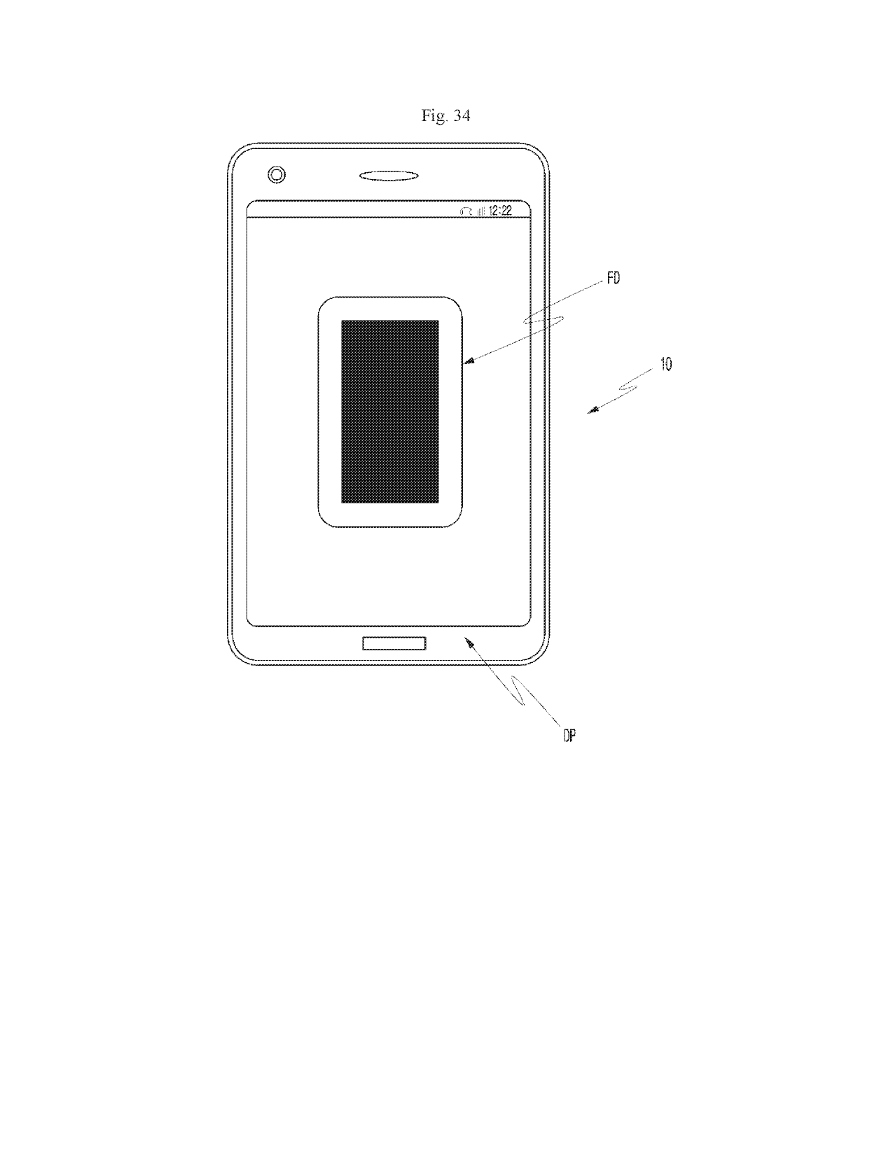

FIG. 34 is a view illustrating a state in which the display device of FIG. 25 is driven in an input window fingerprint recognition mode.

Referring to FIG. 34, in the input window fingerprint recognition mode of a display device DP, a plurality of touch sensors SN which overlap an input window FP displayed on a partial area of the display module 510 are selected.

That is, the display device DP enables a plurality of touch sensors SN which overlap the generated input window FP to be selected and activated in a user verification step such as a step of inputting a fingerprint in the electronic device 10 so that user verification is performed by scanning a fingerprint image.

When the display device DP according to the present embodiment is in the icon fingerprint recognition mode or the input window fingerprint recognition mode, although all of the plurality of touch sensors SN which overlap the security icon ICONs or the input window FP are activated, for other touch sensors SN which do not overlap the security icon ICONs and the input window FP, some of the touch sensors SN classified for each of the touch sensor sectors SS may be activated.

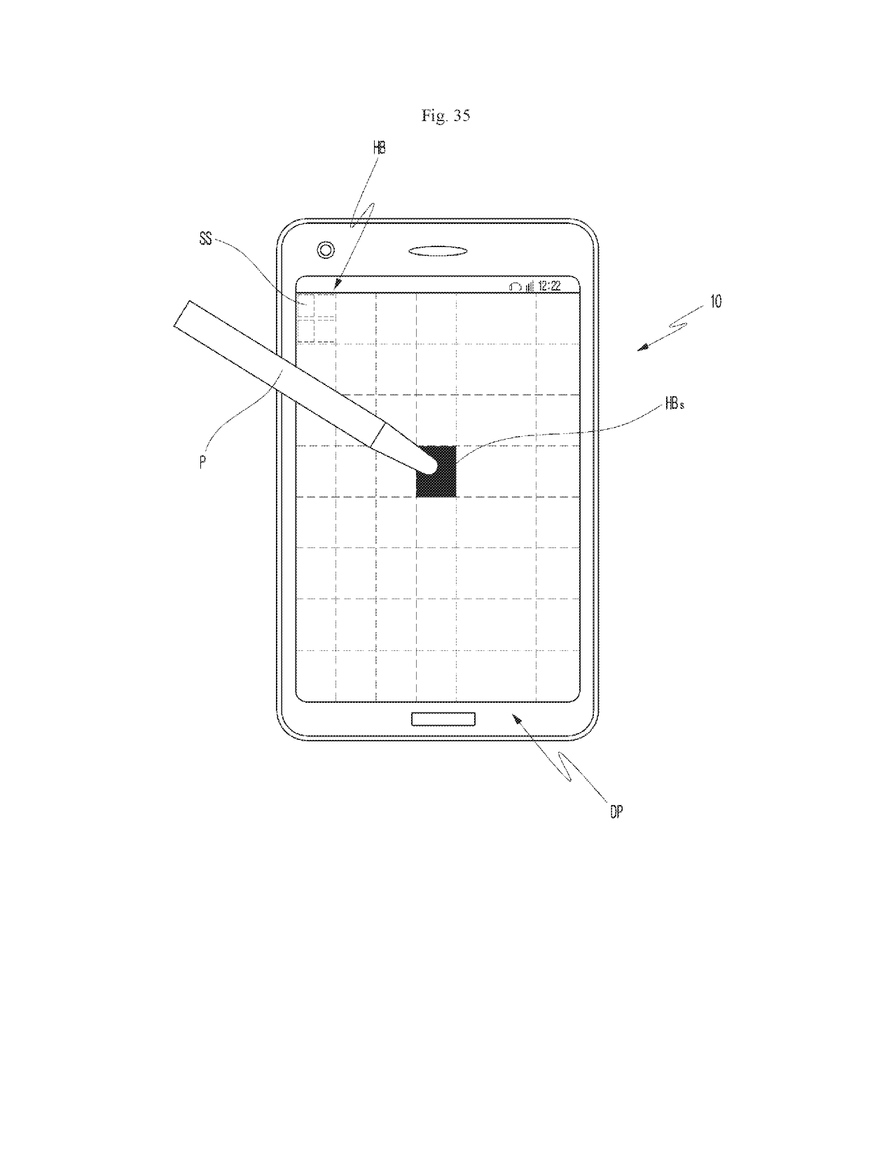

FIG. 35 is a view illustrating a state in which the display device of FIG. 25 is driven in a non-contact recognition mode.

Referring to FIG. 35, the touch sensor module 530 of a display device DP according to the present disclosure further includes a plurality of touch sensor blocks HB which include a plurality of touch sensor sectors SS.

When the touch sensor module 530 is driven in the non-contact recognition mode, the plurality of touch sensor sectors SS included in the plurality of touch sensor blocks HB are activated. Here, some of the touch sensors SN of the touch sensors SN included in each of the touch sensor sectors may be selected and activated as described with reference to FIGS. 25 to 31.

Also, the plurality of touch sensor blocks HB may be activated by overlapping each other like the way in which the plurality of touch sensor sectors SS of FIGS. 25 to 31 are activated, and may detect a non-contact proximity state or a contact state of a contact means P.

Here, a size of a voltage of the scan signal applied from the scan line to the activated touch sensors SN is formed larger compared to the case in which the touch sensor module 530 is driven in the touch recognition mode and the fingerprint recognition mode. As a result, because a larger driving voltage is formed in a larger area compared to the touch recognition mode or the fingerprint recognition mode, a large electromagnetic field capable of detecting whether the contact means P is in the vicinity even in a predetermined distance from the display device DP is formed.

Consequently, even when the contact means P such as a touch pen is disposed adjacent to an upper portion of the display area without directly coming into contact with the display area or the sensing area of the display device DP, the display device DP may sense a touch sensor block HBs pointed by the contact means P.

Because a process of sensing the contact means P which is not in contact with touch sensors SN included in the plurality of touch sensor sectors SS is substantially the same as the configuration of FIGS. 25 to 28 in which the touch sensor SN senses the contact means P and is different therefrom only in terms of a size of a voltage of an applied data signal, the detailed description of the process will be omitted.

The non-contact recognition mode may be a hovering mode in which whether the contact means P is in the vicinity is detected while the contact means P is not in direct contact with the display area or the sensing area of the display device DP.

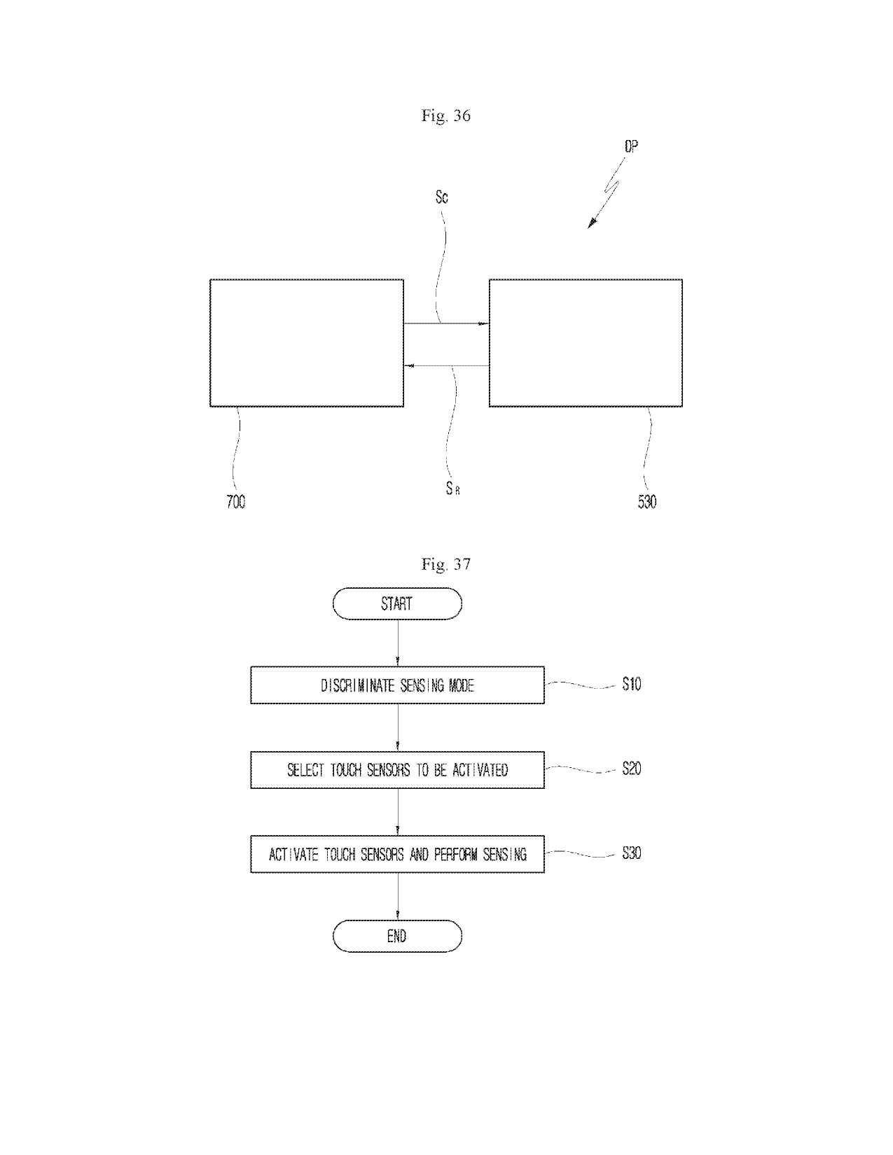

FIG. 36 is a schematic block diagram illustrating a configuration of the display device of FIG. 25, and FIG. 37 is a flowchart illustrating a process of driving the display device of FIG. 25.

Referring to FIGS. 36 and 37, a display device DP according to the present embodiment further includes a controller 700 configured to transmit a control signal Sc to the touch sensor module 530 and receives a sensed signal SR from the touch sensor module 530. Although the controller 700 according to the present embodiment is described as a configuration which is separately provided from the touch sensor module 530, a configuration in which the controller 700 is included in the touch sensor module 530 is also possible.

The controller 700 of the display device DP according to the present embodiment discriminates a sensing mode of the display device DP (S10), selects touch sensors SN to be activated according to the discriminated sensing mode (S20), and then activates the selected touch sensors SN and transmits sensed signals from the activated touch sensors (S30).

More specifically, in the sensing mode discriminating step (S10), the controller 70 discriminates a sensing mode of the display device DP according to a driving state of the electronic device 10 in which the display device DP is installed.

Here, the sensing mode further includes a touch recognition mode for recognizing whether a contact means comes into contact with the display device DP by allowing some of the touch sensors SN of the touch sensors included in the plurality of touch sensor sectors SS of the display device DP to be selected, fingerprint recognition modes for scanning an image of a user fingerprint which comes into contact with the display device SN by allowing a larger number of the touch sensors SN to be selected than in the touch recognition mode, and a non-contact recognition mode for recognizing whether the contact means is in the vicinity of the sensing area by allowing some of the touch sensors SN of the touch sensors SN included in the touch sensor blocks HB to be selected.

When the display device DP is driven in the fingerprint recognition mode, because a larger number of touch sensors SN are activated compared to the case in which the display device DP is driven in the touch recognition mode, the display device DP may have a higher touch recognition resolution so that an image of a user's fingerprint can be scanned.

Also, the fingerprint recognition modes include an entire fingerprint recognition mode which allows all of the touch sensors SN of the display device DP to be selected, an icon fingerprint recognition mode which allows a plurality of touch sensors SN which overlap at least one icon ICONs of a plurality of icons ICON displayed on the display device DP to be selected, and an input window fingerprint recognition mode which allows a plurality of touch sensors SN which overlap the input window FP displayed on a partial area of the display device DP to be selected.

For example, the controller 700 may determine that the display device DP is in the touch recognition mode in a normal driving mode of the electronic device 10, and determine that the display device DP is in the entire fingerprint recognition mode when the electronic device 10 performs an operation of scanning a user's fingerprint throughout an entire area of the display device DP and suppress power consumption of the electronic device 10.

Also, when the touch pen P is detached from the electronic device 10 or the electronic device 10 is in a touch pen P using mode, the controller 700 may determine that the display device DP is in the non-contact recognition mode.

Also, the controller 700 may determine that the display device DP is in the icon fingerprint recognition mode when the security icon ICONs among the plurality of icons ICON is displayed on the electronic device 10, and determine that the display device DP is in the input window fingerprint recognition mode when the fingerprint input window FP is formed in the electronic device 10.

Then, the controller 700 selects touch sensors SN to be activated according to the discriminated sensing mode (S20).

Here, the controller 700 may receive information related to touch sensors SN to be activated for each of the selection modes from a storage provided inside or outside the controller 70 and select the touch sensors SN to be activated.

Then, in the touch sensor activating and sensing step (S30), with respect to the selected touch sensors SN, the controller 70 charges a touch capacitance formed between a sensing electrode SE and the contact means by the reset transistor which is turned on by receiving the first selection signal, generates a current which varies according to a voltage charged in the touch capacitance through the amplifying transistor, and then detects the generated current through the read transistor which is turned on by receiving the second selection signal, and determines whether a contact means is in contact with an upper portion of the touch sensor SN and a contact state thereof.

Also, when the non-contact recognition mode is selected in the sensing mode discriminating step (S10) and the touching sensor activating and sensing step is performed with respect to the touch sensors SN selected according to the non-contact recognition mode, the controller 70 may determine whether a voltage value of a detection signal generated from the touch sensor exceeds a non-contact recognition reference voltage V_{REF}.

In this case, in the reference voltage exceeding determining step, when a voltage value V of the detection signal is equal or lower than the non-contact recognition reference voltage V_{REF}, the controller 70 determines a touch sensor block HB from which the detection signal is generated among the plurality of touch sensor blocks HB as a center of non-contact recognition.

Also, in the non-contact recognition reference voltage exceeding determining step, when a voltage value V of the detection signal exceeds the non-contact recognition reference voltage V_{REF}, the controller 70 performs the touch sensor activating and sensing step (S30) according to the touch recognition mode. When the contact means P is in the vicinity of the display area or the sensing area of the display device DP, the voltage value V of the detection signal detected from the touch sensors SN is formed to be smaller than a voltage value V of the detection signal when the contact means P is directly in contact with the display area or the sensing area of the display device DP. Consequently, the display device DP according to the present embodiment may determine whether the voltage value V of the detection signal exceeds the non-contact recognition reference voltage V_{REF} to determine whether the contact means P is in the vicinity of the display device DP or is in contact therewith.

According to the proposed embodiment, because touch sensors SN of micro-units which may be selectively activated are disposed in the display device DP, there is an advantage in that an image of a user's fingerprint can be scanned or whether a touch is generated by a contact means having a fine diameter such as a pin or a brush can be sensed.

The touch sensors of the display devices described with reference to FIGS. 1 to 37 are described as being connected to the power input terminal VDD or a data line to receive power or a data signal. The power input terminal VDD or the data line refers to a line in which a voltage having a predetermined size for operating the touch sensor is applied and is not limited to the term. Substantially, the power input terminal VDD and the data line may be understood as having concepts corresponding to each other.

The above description is merely illustrative of the present disclosure, and one of ordinary skill in the art to which the present disclosure pertains should understand that the present disclosure may be easily modified in other specific forms without changing the technical spirit or essential features of the present disclosure. Therefore, the embodiments described above are illustrative in all aspects and should not be understood as limiting. For example, each element described as having an integrated form may be embodied in a distributed manner, and likewise, elements which are described as being distributed may be embodied in an integrated form.

The above description is merely illustrative of the present disclosure, and one of ordinary skill in the art to which the present disclosure pertains should understand that the present disclosure may be easily modified in other specific forms without changing the technical spirit or essential features of the present disclosure. Therefore, the embodiments described above are illustrative in all aspects and should not be understood as limiting. For example, each element described as having an integrated form may be embodied in a distributed manner, and likewise, elements which are described as being distributed may be embodied in an integrated form.

The scope of the present disclosure is defined by the claims below, and all modifications or modified forms derived from the meaning and scope of the claims and concepts equivalent thereto should be interpreted as belonging to the scope of the present disclosure.

Although exemplary embodiments of the present disclosure have been described above, the present disclosure is not limited thereto and may be embodied by being modified in various ways within the scope of the claims, the detailed description, and the accompanying drawings. Such modifications belong to the scope of the present disclosure.

### INDUSTRIAL APPLICABILITY

The present disclosure relates to a method of driving a display device capable of scanning an image and is industrially applicable due to being applicable to various types of display devices and having reproducibility.

1. A method of driving a display device capable of scanning an image, the display device including a display module including a plurality of pixel units arranged in a display area on which an image is displayed and a touch sensor module having a sensing area which overlaps the display area and including one or more touch sensors respectively corresponding to the pixel units, the method comprising:
a sensing mode discriminating step in which a sensing mode of the display device is discriminated;
a touch sensor selecting step in which touch sensors to be activated are selected according to the discriminated sensing mode, and
a touch sensor activating and sensing step in which the selected touch sensors are activated and a sensed signal is received from the activated touch sensors.

2. The method of claim 1, wherein, in the sensing mode discriminating step, the sensing mode includes:
a touch recognition mode for recognizing whether a contact means comes into contact with the display device by partitioning the sensing area of the display device and allowing some touch sensors of the touch sensors included in a plurality of touch sensor sectors including the touch sensors disposed in the partitioned area to be selected; and
fingerprint recognition modes for scanning an image of a user's fingerprint which touches the display device by allowing a larger number of the touch sensors to be selected than in the touch recognition mode.

3. The method of claim 2, wherein:
the touch sensors are connected to a scan line to which a scan signal for providing a driving voltage to the touch sensors is applied;
the touch sensor module further includes a plurality of touch sensor blocks each including two or more of the touch sensor sectors;
the sensing mode further includes a non-contact recognition mode for recognizing whether the contact means is in the vicinity of the sensing area by allowing some touch sensors of the touch sensors included in the touch sensor blocks to be selected; and
when the non-contact sensing mode is selected, a size of a voltage of the scan signal applied to the touch sensors is larger compared to when any one of the touch recognition mode and the fingerprint recognition mode is selected.

4. The method of claim 3, further comprising a reference voltage exceeding determining step in which whether a voltage value of a detection signal generated from the touch sensors exceeds a non-contact recognition reference voltage is determined when the non-contact recognition mode is selected in the sensing mode discriminating step and the touch sensor activating and sensing step is performed on the touch sensors selected according to the non-contact recognition mode, wherein:
in the reference voltage exceeding determining step, when the voltage value of the detection signal is the reference voltage or lower, the touch sensor block from which the detection signal is generated among the plurality of touch sensor blocks is determined as a center of non-contact recognition; and
in the reference voltage exceeding determining step, when the voltage value of the detection signal exceeds the reference voltage, the touch sensor activating and sensing step is performed according to the touch recognition mode.

5. The method of claim 2, wherein the fingerprint recognition modes include:
an entire fingerprint recognition mode which allows all of the touch sensors of the display device to be selected;
an icon fingerprint recognition mode which allows a plurality of touch sensors which overlap at least one icon of a plurality of icons displayed on the display device to be selected; and
an input window fingerprint recognition mode which allows a plurality of touch sensors which overlap an input window displayed on a partial area of the display device to be selected.

6. The method of claim 2, wherein, in the sensing mode discriminating step, when any one of the icon fingerprint recognition mode and the input window fingerprint recognition mode is selected from the fingerprint recognition modes, some touch sensors of the touch sensors disposed in an area excluding an area in which the touch sensors overlapping the icon or the input window are disposed are further selected.

7. The method of claim 2, wherein, in the sensing mode discriminating step, when the touch recognition mode is selected, the selected touch sensors of the touch sensor sectors are disposed along an edge of the touch sensor sector or randomly disposed in the touch sensor sector.

8. The method of claim 2, further comprising a touch point determining step in which a touch point is determined on the basis of sensed information received from the touch sensors from which contact of the contact means overlapping the plurality of touch sensors is sensed, wherein
in the touch point determining step, 1) a center of the touch sensor sector including the largest number of touch sensors of the touch sensors from which the contact is sensed or 2) a calculated center which is spaced apart, by a weighted average value of the number of touch sensors from which the contact is sensed included by each of the touch sensor sectors, from centers of the touch sensor sectors including the touch sensors from which the contact is sensed are determined as a center of a touch point.

9. The method of claim 2, wherein, of the plurality of touch sensor sectors, any one touch sensor sector and another touch sensor sector adjacent thereto share one or more touch sensors.

10. The method of claim 2, wherein the touch sensor which is not included in any of the touch sensor sectors is disposed between any one touch sensor sector of the touch sensor sectors and another touch sensor sector adjacent thereto.

11. The method of claim 1, wherein:
the touch sensor includes a sensing electrode configured to form a touch capacitance by contact with a contact means and formed of a transparent material, and a transistor part including one or more transistors connected to the sensing electrode;
the sensing electrode overlaps the pixel unit of the display module; and
light for displaying an image passes through the sensing electrode from the pixel unit.

12. The method of claim 11, wherein the transistor part includes:
a reset transistor in which a drain electrode is connected to the sensing electrode and any one of a gate electrode and a source electrode is connected to a first scan line to which a first selection signal is applied or a data line which provides a data signal;
an amplifying transistor in which a gate electrode is connected to the drain electrode of the reset transistor and a source electrode is connected to any one of the first scan line, the data line, and a second scan line to which a second selection signal, which is different from the first selection signal, is applied; and
a read transistor in which a drain electrode is connected to the drain electrode of the amplifying transistor, a gate electrode is connected to the second scan line to which the second selection signal is applied, and a source electrode is connected to a readout line for detecting a current corresponding to the touch capacitance.

13. The method of claim 12, wherein the touch sensor activating and sensing step includes:
charging the touch capacitance formed between the sensing electrode and the contact means through the reset transistor which is turned on by receiving the first selection signal;
generating a current which varies according to a voltage charged in the touch capacitance through the amplifying transistor; and
determining whether a touch is generated on an upper portion of the touch sensor and a contact state by detecting the generated current through the read transistor which is turned on by receiving the second selection signal.

14. The method of claim 12, wherein the sensing electrode is disposed higher than the reset transistor, the amplifying transistor, the read transistor, the first scan line, the second scan line, the data line, and the readout line.

15. The method of claim 14, wherein the sensing electrode covers one or more of the reset transistor, the amplifying transistor, the read transistor, a portion of the first scan line, a portion of the second scan line, a portion of the data line, and a portion of the readout line.

16. The method of claim 14, wherein:
the reset transistor, the amplifying transistor, and the read transistor are disposed not to cover unit color pixels of a color filter layer of the display module; and
the sensing electrode is disposed to cover at least some of the unit color pixels.

17. The method of claim 14, wherein any one touch sensor of the plurality of touch sensors and another touch sensor adjacent thereto are connected to the single data line, and the touch sensor and the other touch sensor adjacent thereto are symmetrical with respect to the data line.

18. The method of claim 12, wherein:
the data line is formed of a plurality of data lines to which data signals formed independent of each other are respectively input;
sequentially formed scan signals are respectively input to the plurality of scan lines including the first scan line and the second scan line;
a touch sensor to which a scan signal and a data signal are simultaneously input is activated, and a touch sensor to which at least one of the scan signal and the data signal is not input is not activated.

19. The method of claim 1, wherein:
the display device further includes a protective layer having one surface coming into contact with the sensing electrode of the touch sensor and the other surface coming into contact with a user's fingerprint; and
an image of the user's fingerprint is scanned by detecting currents having different values according to touch capacitances of ridges and valleys of the user's fingerprint which touches the protective layer.

20. The method of claim 1, wherein:
a gap is formed between a sensing electrode of any one touch sensor of the plurality of touch sensors and a sensing electrode of another touch sensor;
the sensing electrode of the touch sensor and a single gap adjacent thereto form a single sensing pitch; and
a width of the sensing pitch is any one selected from a range of 5 μm to 200 μm.
